(19) United States
(12) Patent Application Publication
(10) Pub. No.: US 2008/0068343 A1
(43) Pub. Date: Mar. 20, 2008

(54) Tactile pin display apparatus

(76) Inventors: Takeshi Hoshino, Kodaira (JP); Sergio Paolantonio, Kokubunji (JP); Arito Mochizuki, Musashino (JP)

Correspondence Address: MATTINGLY, STANGER, MALUR & BRUNDIDGE, P.C., 1800 DIAGONAL ROAD, SUITE 370, ALEXANDRIA, VA, 22314, US

(21) Appl. No.: 11/710,515

(22) Filed: Feb. 26, 2007

(30) Foreign Application Priority Data
Sep. 14, 2006 (JP) 2006-248941

(51) Int. Cl. G06F 3/041

(52) U.S. Cl. 345/173

(57) ABSTRACT

A pin matrix having a plurality of pins disposed in a matrix pattern is mounted on a display unit disposed on an upper surface of a dot figure display main body in the housing of a dot figure display apparatus. As pins are driven, a dot figure capable of being touched and sensed is displayed. Infrared rays are irradiated from an infrared LED to the pin matrix. A video camera receives infrared rays reflected from a recursive reflection marker attached to a main finger tip to detect the position of the main finger tip on the pin matrix. A pressure sensor is mounted at each corner of the dot figure display main body. A pressure barycenter position and a press force relative to the pin matrix are calculated from a pressure detected with each pressure sensor. The manipulation state of the pin matrix is judged from the main finger tip touch position, pressure barycenter position and press force.

### INCORPORATION BY REFERENCE

The present application claims priority from Japanese application JP2006-248941 filed on Sep. 14, 2006, the content of which is hereby incorporated by reference into this application.

### BACKGROUND OF THE INVENTION

1. Field of the Invention

The present invention relates to a dot figure display apparatus equipped with a screen having a plurality of tactile pins disposed in a matrix pattern.

2. Description of the Related Art

A dot figure display apparatus is known in which a plurality of thin pins are disposed in a matrix shape and the pins are allowed to be driven up and down by using piezoelectric elements. Desired pins are protruded to display information such as characters, figures, and images. By touching these pin matrix with a finger tip, such information can be recognized by the finger, i.e., touch sense (tactile sensation).

In one example, this dot figure display apparatus is applied to a mouse which is used by an operator such as a visually disabled person to operate a personal computer. A pin matrix is mounted on an operation plane of a mouse to draw a character or a figure. In an area where a character or figure is displayed, pins are driven to change the displayed character or figure. If the displayed character or figure is not necessary to be changed, the pins are fixed. A portion of the peripheral area of the pin matrix is used for notifying an operator of control information. In this portion, pins are vibrated by protruding and retracting them at different vibration frequencies to notify an operator of various control information (for example, refer to JP-A-10-187025).

In another example, there is a method of displaying a screen of a graphical user interface on a tactile board made of pins disposed in an array. This method allows the size of a display area of the screen on the tactile board to be changed by operating a predetermined key on a keyboard (for example, refer to JP-A-11-161152).

In still another example, a text layout is set to a matrix tactile display, and data such as a text is assigned to the preset layout to display the data. A layout to be set and its position and data are selected, and the layout is set based on the selection to display the selected data (for example, refer to JP-A-2000-206871).

A dot figure displayed by a conventional pin matrix is used to supply an operator with information. Information input from the operator has not been considered. If an operator is, e.g., a visual disabled person, supplied information can be recognized by a dot figure on the pin matrix. However, an information input operation is not possible by using the pin matrix to be touched for information reading. In order to input information, a device different from the pin matrix has been used.

According to the techniques described in JP-A-10-187025, characters, figures and the like can be displayed by a pin matrix, and control information can be displayed. An operator touches a dot figure with finger tips or the like to recognize information by touch sense. If control information is to be input from a mouse, a device different from the pin matrix is required to be used.

The invention described in JP-A-11-161152 changes the size of a display area of the tactile board on which a graphical user interface is displayed. In changing the size, a predetermined key on a keyboard is required to be operated.

The techniques described in JP-A-2000-206871 form a text layout on a tactile pin display of a matrix shape. In selecting a text layout, its position and data, a key board and a mouse are operated in accordance with an operation menu in the form of voice output, and the operation result is displayed on the tactile pin display.

With a conventional dot figure display apparatus of a pin matrix, although information can be supplied to an operator, the operator cannot input information.

Not only visually disabled persons but also ordinary persons may enter circumstances that they cannot perform necessary operations while visually confirming the display screen of a car navigation device during running the vehicle or a portable terminal during commutation in a jammed train. It is desired to solve these circumstances.

### SUMMARY OF THE INVENTION

The present invention has been made in consideration of such circumstances, and an object of the present invention is to provide a dot figure display apparatus capable of inputting information by using a pin matrix for displaying a dot figure.

In order to achieve the object of the invention, the present invention provides a dot figure display apparatus for displaying a dot figure on a pin matrix having a plurality of pins disposed in a matrix pattern on an upper surface of a dot figure display main body and allowing touch sense of the dot figure by touching the pin matrix with a finger tip, the dot figure display apparatus comprising: an infrared LED for irradiating infrared rays to a surface of the pin matrix; a video camera for receiving the infrared rays reflected and detecting an infrared ray image reflected from a main finger tip depressed the pin matrix; a pressure sensor for detecting a press force to the pin matrix; and a control unit for detecting a touch position of the main finger tip on the pin matrix as a main finger tip touch position, in accordance with a detection result of the reflected infrared ray image of the video camera and detecting a press force to the pin matrix from a detection output of the pressure sensor.

The present invention provides a dot figure display apparatus for displaying a dot figure on a pin matrix having a plurality of pins disposed in a matrix pattern on an upper surface of a dot figure display main body and allowing touch sense of the dot figure by touching the pin matrix with a finger tip, the dot figure display apparatus comprising: an infrared LED for irradiating infrared rays to a surface of the pin matrix; a video camera for receiving the infrared rays reflected to detect infrared rays reflected from a marker made of recursive reflection material and attached to a main finger tip depressed the pin matrix; a pressure sensor for detecting a press force to the pin matrix; and a control unit for detecting a touch position of the main finger tip on the pin matrix as a main finger tip touch position, in accordance with a detection result of the reflected infrared rays from the marker and detecting a press force to the pin matrix from a detection output of the pressure sensor.

The present invention provides a dot figure display apparatus for displaying a dot figure on a pin matrix having a plurality of pins disposed in a matrix pattern on an upper surface of a dot figure display main body and allowing touch sense of the dot figure by touching the pin matrix with a finger tip, the dot figure display apparatus comprising: an infrared LED for irradiating infrared rays to a surface of the pin matrix; a video camera for receiving the infrared rays reflected to detect infrared rays reflected from a marker made of recursive reflection material and attached to a main finger tip depressed the pin matrix; a plurality of pressure sensors for detecting a press force to the pin matrix; and a control unit for detecting a touch position of the main finger tip on the pin matrix as a main finger tip touch position, in accordance with a detection result of the reflected infrared rays from the marker and detecting a pressure barycenter position on and a press force to the pin matrix from a detection output of the plurality of pressure sensors.

In the present invention, the video camera includes a first video camera and a second video camera, and the infrared LED is disposed in front of the first and second video cameras, and the control unit detects a direction from the first video camera toward the marker in accordance with the detection result of the reflected infrared rays from the marker by the first video camera, detects a direction from the second video camera toward the marker in accordance with the detection result of the reflected infrared rays from the marker by the second video camera, and detects the main finger tip touch position on the pin matrix in accordance with the direction from the first video camera toward the marker and the direction from the second video camera toward the marker.

The present invention further comprising: a projector screen covering a whole area of the pin matrix; and a projector for projecting a character, a figure, a map, an image and the like on the projector screen.

In the present invention, if a detected value of the press force is a threshold value or larger, the control unit judges that the pin matrix was subjected to a touch manipulation, and in accordance with the touch manipulation, controls the dot figure displayed on the pin matrix. In the present invention, if the press force by the main finger tip is the threshold value or larger and if the main finger tip touch position and the pressure barycenter position are in a range of the dot figure, the control unit controls to move or rotate the dot figure while the main finger tip touch position and the pressure barycenter position move.

In the present invention, if the press force is the threshold value or larger and if the main finger tip touch position and the pressure barycenter position are in a range of the dot figure, the control unit controls to change a size of the dot figure in accordance with a distance between the main finger tip touch position and the pressure barycenter position.

In the present invention, if the press force is the threshold value or larger and if the main finger tip touch position and the pressure barycenter position are in a range of the dot figure, the control unit controls to rotate the dot figure by using the main finger tip touch position as a rotation center, while the pressure barycenter position rotates by using the main finger tip touch position as a rotation center.

In the present invention, the dot figure displayed on the pin matrix includes a plurality of numerical value display areas for displaying a numerical value, and if the press force is the threshold value or larger and if the main finger tip touch position is in a range of the dot figure of a predetermined numerical value display area among the plurality of numerical value display areas, the control unit controls to change a numerical value displayed in the predetermined numerical value display area, in accordance with a relation between the pressure barycenter position corresponding to depression of the pin matrix with a finger tip other than the main finger tip and a position of the predetermined numerical value display area.

In the present invention, the dot figure displayed on the pin matrix represents a floor operation unit of an elevator having a plurality of floor select buttons, and if the press force is the threshold value or larger and if the main finger tip touch position is in a range of the dot figure of a predetermined floor select button, the control unit judges that a floor was designated by the predetermined floor select button, and outputs a command for moving the elevator to the designated floor to an elevator device.

In the present invention, the floor operation unit is provided in an elevator position display unit having a floor bar showing each floor by the dot figure; and a position bar showing a position of the elevator, and the control unit controls to move the position bar in the elevator position display unit while the elevator moves.

In the present invention, the dot figure displayed on the bin matrix includes a text constituted of a character string and a scroll button for scrolling the text, and if the pressure barycenter position is in a range of the dot figure of the scroll button, the control unit controls to scroll the text.

In the present invention, the dot figure displayed on the bin matrix displays an operation unit having a volume adjusting unit and an operation button of a sound reproducing apparatus, and if the press force by the main finger tip is the threshold value or larger and if the main finger tip touch position is at a position of a volume adjusting bar of the volume adjusting unit, the control unit controls to change a reproduction volume of the sound reproducing apparatus while the main finger tip touch position moves.

According to the present invention, it is possible to recognize the main finger tip touch position of the main finger tip on the pin matrix, the pressure barycenter position and the press force. It is therefore possible to perform a control operation of the dot figure on the pin matrix and a control operation of other apparatuses, in accordance with the recognition results.

Other objects, features and advantages of the invention will become apparent from the following description of the embodiments of the invention taken in conjunction with the accompanying drawings.

### BRIEF DESCRIPTION OF THE DRAWINGS

FIGS. 1A and 1B are schematic diagrams showing the structure of a dot figure display apparatus according to a first embodiment of the present invention.

FIGS. 2A to 2C are schematic diagrams showing a specific example of a pin matrix shown in FIGS. 1A and 1B.

FIGS. 3A and 3B are illustrative diagrams showing a method of detecting a press barycenter position of the pin matrix shown in FIGS. 1A and 1B.

FIGS. 4A and 4B are block diagrams showing specific examples of a system used by the dot figure display apparatus shown in FIGS. 1A and 1B.

FIG. 5 is a diagram showing the relation between an operator manipulation and a press force Ps at a pressure barycenter position detected by a control unit shown in FIGS. 4A and 4B.

FIGS. 6A and 6B are diagrams showing the relation between a finger tip press state and its recognition state on the pin matrix based on FIG. 5 and by the control unit shown in FIGS. 4A and 4B.

FIGS. 7A and 7B are diagrams showing a first example of a display state of a dot figure on the pin matrix made by an operator operating the apparatus of the first embodiment shown in FIGS. 1A and 1B having the systems shown in FIGS. 4A and 4B.

FIGS. 8A and 8B are diagrams showing a second example of a display state of a dot figure on the pin matrix made by an operator operating the apparatus of the first embodiment shown in FIGS. 1A and 1B having the systems shown in FIGS. 4A and 4B.

FIGS. 9A and 9B are diagrams showing a third example of a display state of a dot figure on the pin matrix made by an operator operating the apparatus of the first embodiment shown in FIGS. 1A and 1B having the systems shown in FIGS. 4A and 4B.

FIGS. 10A and 10B are diagrams showing a fourth example of a display state of a dot figure on the pin matrix made by an operator operating the apparatus of the first embodiment shown in FIGS. 1A and 1B having the systems shown in FIGS. 4A and 4B.

FIGS. 11A and 11B are diagrams showing a fifth example of a display state of a dot figure on the pin matrix made by an operator operating the apparatus of the first embodiment shown in FIGS. 1A and 1B having the systems shown in FIGS. 4A and 4B.

FIGS. 12A to 12C are diagrams showing a sixth example of a display state of a dot figure on the pin matrix made by an operator operating the apparatus of the first embodiment shown in FIGS. 1A and 1B having the systems shown in FIGS. 4A and 4B.

FIGS. 13A to 13C are enlarged views of a main portion of a floor select unit shown in FIGS. 12A to 12C.

FIGS. 14A and 14B are diagrams showing a seventh example of a display state of a dot figure on the pin matrix made by an operator operating the apparatus of the first embodiment shown in FIGS. 1A and 1B having the systems shown in FIGS. 4A and 4B.

FIGS. 15A and 15B are diagrams showing a eighth example of a display state of a dot figure on the pin matrix made by an operator operating the apparatus of the first embodiment shown in FIGS. 1A and 1B having the systems shown in FIGS. 4A and 4B.

FIG. 16 is an enlarged schematic perspective view showing a main portion of a volume adjust unit shown in FIGS. 15A and 15B.

FIGS. 17A and 17B are schematic diagrams showing the structure of a dot figure display apparatus according to a second embodiment of the present invention.

FIG. 18 is a diagram illustrating a method of detecting a position (i.e., main finger tip touch position) of a marker of the second embodiment shown in FIGS. 17A and 17B.

FIGS. 19A to 19C are outer perspective views of a dot figure display apparatus according to a third embodiment of the present invention.

### DESCRIPTION OF THE EMBODIMENT

Embodiments of the present invention will be described with reference to the accompanying drawings.

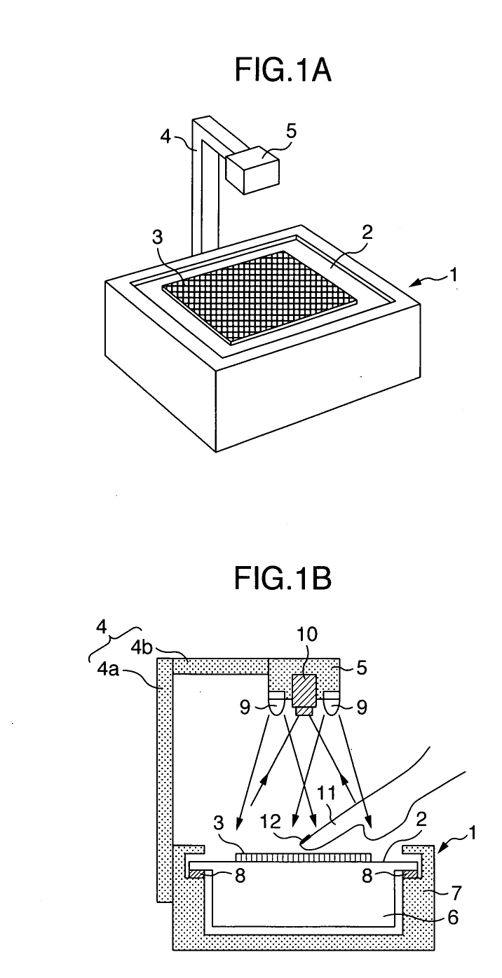

FIGS. 1A and 1B are schematic diagrams showing the structure of a dot figure display apparatus according to the first embodiment of the present invention. FIG. 1A is an outer perspective view showing the overall structure, and FIG. 1B is a vertical cross sectional view of FIG. 1A. The apparatus 1 has a display unit 2, a pin matrix 3, a support member 4, a holder unit 5, a dot figure display main body 6, a housing 7, pressure sensors 8, infrared light emitting diodes (LED) 9, and a video camera 10. Reference numeral 11 represents a main finger tip, and reference numeral 12 represents a marker.

Referring to FIGS. 1A and 1B, the apparatus 1 of the first embodiment has the holder 5 supported by the support unit 4. The dot figure display main body 6 is disposed in the housing 7 of the apparatus 1. The display unit 2 is constituted of the upper portion of the dot figure display main body 6, and the pin matrix 3 is mounted on the display unit 2. The pin matrix 3 constitutes a dot figure display screen of the dot figure display apparatus. The dot figure display main body 6 is supported by the housing 7, for example, at four corners via pressure sensors 8. In FIG. 1B, the pressure sensors 8 at two corners are schematically shown.

In this example, the support unit 4 is constituted of a vertical part 4a whose one end portion is fixed to the side of the housing 7 and a horizontal part 4b whose one end is connected to the other end of the vertical part 4a. The holder 5 is mounted on the other end of the horizontal part 4b. Therefore, the holder 5 is disposed facing generally the center areas of the dot figure display screen of the pin matrix 3 of the display unit 2. The support unit 4 is not necessarily required to have this structure, but an inverted L-character member may be formed integrally with the housing 7.

On the lower side of the holder 5 facing the dot figure display screen of the pin matrix 3, the video camera 10 is mounted, and one or a plurality of infrared LEDs 9 are mounted near the video camera 10 (in this example, although two infrared LEDs are shown, one LED may be used or three or more LEDs may be used). The infrared LEDs 9 irradiate infrared rays to the entirety of the dot figure display screen of the pin matrix 3. The video camera 10 takes the whole image of the dot figure display screen of the pin matrix 3. The video camera 10 has a filter (infrared ray passing filter) which passes only infrared rays and cuts optical rays in another wavelength range such as visual rays and takes an image of infrared rays reflected from the surface of the pin matrix 3 and the like.

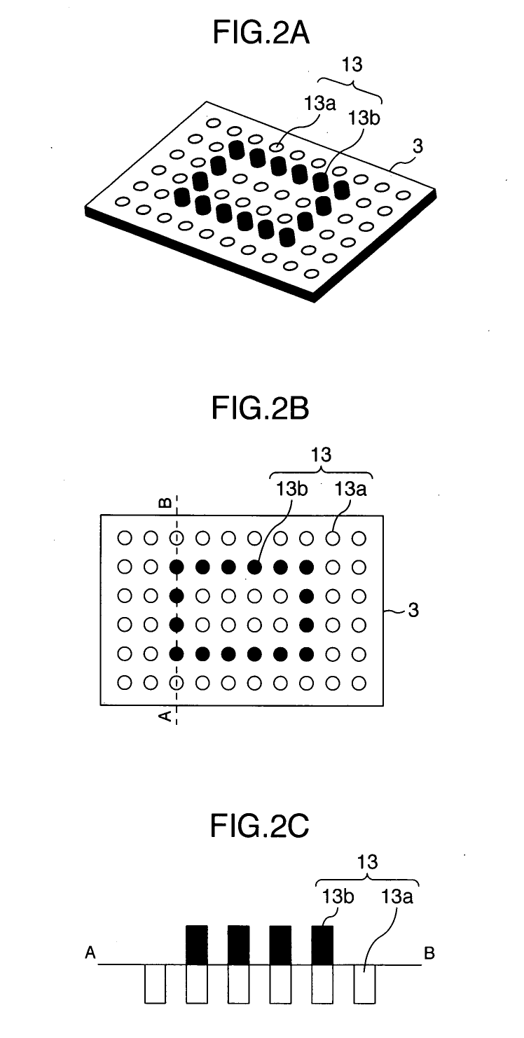

FIGS. 2A to 2C are schematic diagrams showing a specific example of the pin matrix shown in FIGS. 1A and 1B. FIG. 2A is a perspective view viewed from an upper position, FIG. 2B is a plan view and FIG. 2C is a cross sectional view taken along broken line A-B shown in FIG. 2B.

Referring to FIGS. 2A to 2C, the pin matrix 3 has a plurality of pins 13 disposed in a matrix pattern. The pins 13 can take a protruded state (protrusion state) and a state not protruded (non-protrusion state) by pin drive means (not shown). For the purposes of convenience, a pin 13 shown by a white circle is called a non-protrusion pin 13a and a pin 13 shown in back in the protrusion state is called a non-protrusion pin 13b. In the pin matrix 3, some pins 13 are used as the protrusion pins 13b and the other pins 13 are used as the non-protrusion pins 13a. A combination of non-protrusion pins 13a and protrusion pins 13b forms information (hereinafter collectively called touch sense information) such as characters, figures and images which can be recognized by touch sense of protrusion and non-protrusion of pins 13. Touch sense information can therefore be displayed on the dot figure display screen of the pin matrix 3.

Reverting to FIGS. 1A and 1B, as an operator touches the pin matrix 3 displaying touch sense information with a finger tip to sense protrusion and non-protrusion of the pins 13, the touch sense information can be recognized (touch sense).

In the first embodiment, when the dot figure display screen of the pin matrix 3 is touched with a finger tip or when a pin of the pin matrix is depressed with a finger tip, the pressure sensors 8 mounted at four corners of the pin matrix 3 detect pressures applied to the four corners.

In the first embodiment, various controls to be described later can be conducted by touching a predetermined position on the dot figure display screen of the pin matrix 3 and manipulating this position. In order to enable to detect a touch position by a manipulating finger tip, a marker 12 made of recursive reflection material of a sheet shape or a sack shape is attached to the nail of a finger tip or the like. As well known, the recursive reflection material reflects an irradiated light always along the irradiation direction. By disposing the infrared LEDs 9 near the video camera 10, it becomes possible to reflect infrared rays irradiated from the infrared LEDs 9 along the direction toward the video camera 10. Therefore, even if the marker 12 made of recursive reflection material is at any position on the dot figure display screen of the pin matrix 3, infrared rays reflected by the marker 12 can be received by the video camera 10. A light reception position of a reflected infrared ray on the imaging plane of the video camera 10 changes with the position of the marker 12 on the dot figure display screen of the pin matrix 3. Therefore, by detecting the light reception position, it is possible to detect the position of the marker 12 on the dot figure display screen of the pin matrix 3.

The finger tip attached with the marker 12 is called a main finger tip 11. A position touched with this main finger tip 11 can be detected. This touch position is called hereinafter a main finger tip touch position.

The infrared LEDs 9 and video camera 10 detect a position of the marker 12 on the dot figure display screen of the pin matrix 3, whereas the pressure sensors 8 detect a barycenter of a press point (hereinafter called a pressure barycenter position) on the dot figure display screen of the pin matrix 3.

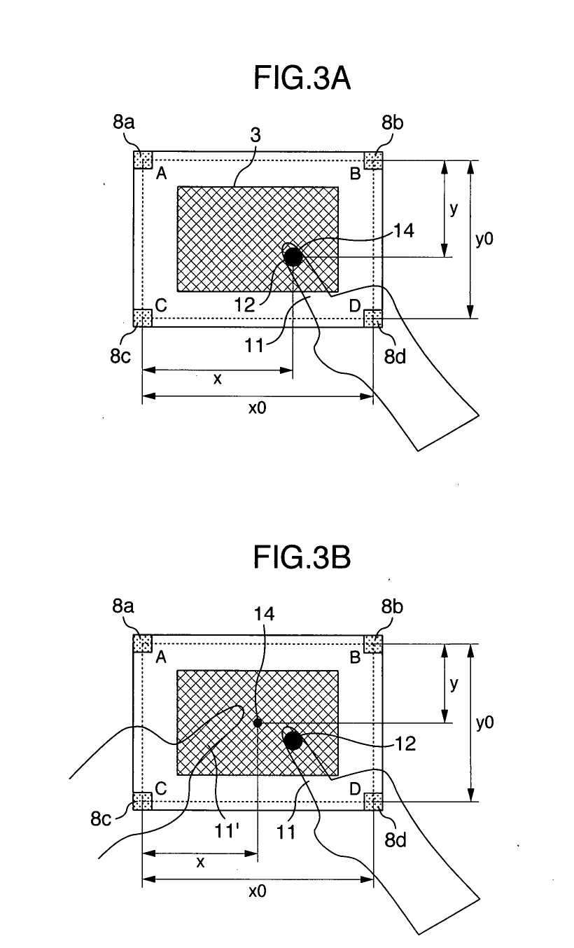

FIGS. 3A and 3B are illustrative diagrams showing a method of detecting a pressure barycenter position of the pin matrix 3. Reference symbols 8a to 8d represent the pressure sensors 8, reference symbol 11′ represents a sub finger tip, and reference numeral 14 represents a pressure barycenter position. Elements corresponding to those shown in FIG. 1 are represented by identical reference symbols, and a duplicated description is omitted.

FIG. 3A shows the state that a pressure is applied to a predetermined position of the pin matrix 3 with the main finger tip 11 attached with the recursive reflection member 12. The pressure sensor 8 is mounted at four corners of the dot figure display main body 6. The pressure sensor 8 at the upper left corner is called a pressure sensor 8a, the pressure sensor 8 at the upper right corner is called a pressure sensor 8b, the pressure sensor 8 at the lower left corner is called a pressure sensor 8c, the pressure sensor 8 at the lower right corner is called a pressure sensor 8d.

Consider now an x-y coordinate system in which the position of the pressure sensor 8a is an origin, a direction (horizontal direction) from the pressure sensor 8a toward pressure sensor 8b is an x coordinate axis direction and a direction (vertical direction) from the pressure sensor 8a to pressure sensor 8c is a y coordinate axis direction.

As the dot figure display screen of the pin matrix 3 is depressed with the main finger tip 11, pressures are detected with the pressure sensors 8a to 8d. Pressures detected by the pressure sensors 8a, 8b, 8c and 8d are represented by A, B, C and D, respectively. A distance (horizontal width of the display unit 2) between the pressure sensors 8a and 8b and between the pressure sensors 8c and 8d is represented by x0, a distance (vertical width of the display unit 2) between the pressure sensors 8a and 8c and between the pressure sensors 8b and 8d is represented by y0, and a coordinate position of the pressure barycenter position 14 is represented by (x, y). The following equations are satisfied.

(A+C):(B+D)=(x0−x):x

(A+B):(C+D)=(y0−y):y

therefore:

x=x0·(B+D)/(A+B+C+D) (1)

y=y0·(C+D)/(A+B+C+D) (2)

### It is therefore possible to calculate the coordinate position (z y) of the pressure barycenter position 14 on the pin matrix 3, from the pressures detected with the pressure sensors 8a, 8b, 8c and 8d.

If a pressure is applied to the dot figure display screen of the pin matrix 3 by only the main finger tip 11 attached with the recursive reflection member, the mount position of the marker 12 on the main finger tip 11 is at the pressure barycenter position 14, and the position of the marker 12 detected from imaging outputs of the video camera 10 coincides with the pressure barycenter position 14 detected from the outputs of the pressure sensors 8a to 8d.

As shown in FIG. 3B, if a pressure is applied to a position different from that of the main finger tip 11 with a finger tip (hereinafter called a sub finger tip) 11′ different from the main finger tip 11 attached with the marker 12, the pressure barycenter position 14 shifts in the direction from the main finger tip 11 toward the sub finger tip 11′. This pressure barycenter position 14 can be calculated also from the above equations (1) and (2). In this case, the position of the marker 12 detected from imaging outputs of the video camera 10 is different from the pressure barycenter position 14.

As described above, in the first embodiment, a position of the main finger tip 11 attached with the marker 12 on the dot figure display screen of the pin matrix 3 detected with the video camera 10 is a position touched with the main finger tip 11. The pressure barycenter position 14 detected from outputs of the pressure sensors 8a to 8d is also the touch position on the dot figure display screen of the pin matrix 3. If only the main finger tip 11 attached with the marker 12 touches the dot figure display screen, the main finger touch position and pressure barycenter 14 are coincident. However if both the main finger 11 attached with the marker 12 and another sub finger tip 11′ touch the dot figure display screen on the pin matrix 3, the main finger touch position is different from the pressure barycenter position 14.

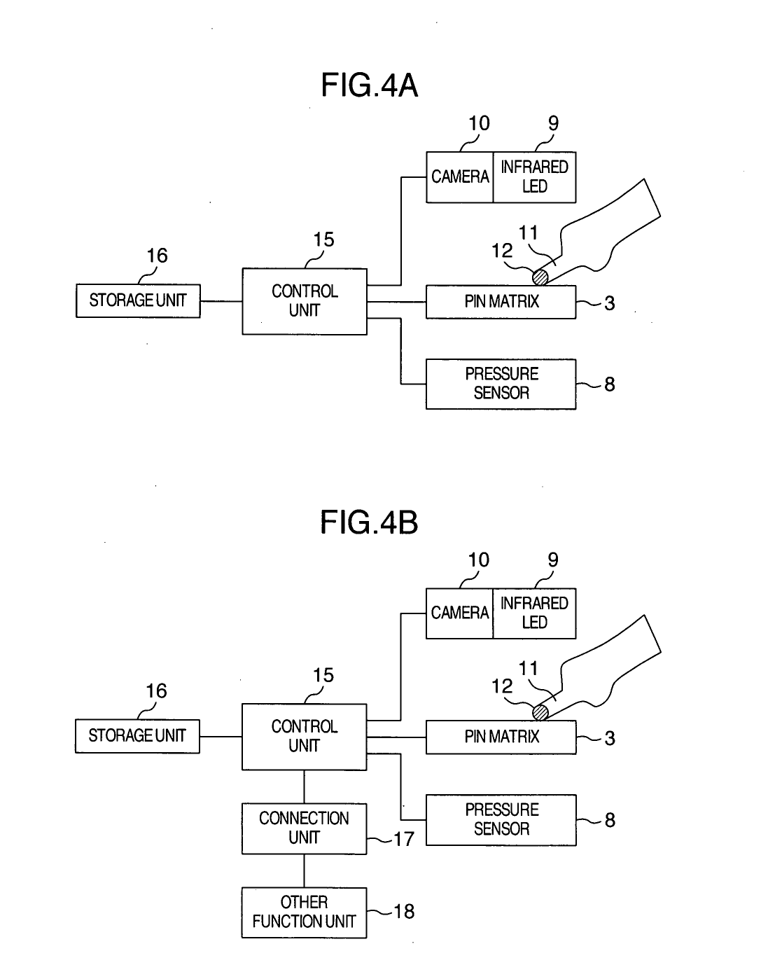

FIGS. 4A and 4B are block diagrams showing specific examples of a system used by the dot figure display apparatus 1 shown in FIGS. 1A and 1B. Reference numeral 15 represents a control unit, reference numeral 16 represents a storage unit, reference numeral 17 represents a connection unit, and reference numeral 18 represents another function unit. Elements corresponding to those shown in the above-described drawings are represented by identical reference symbols, and a duplicated description is omitted.

A specific example shown in FIG. 4A shows the system configuration built in a discrete apparatus of the first embodiment not connected to another apparatus via a network, i.e., a stand-alone apparatus.

In this system, the storage unit 16 stores information on characters, figures, images and the like (collectively called image information). The control unit 15 processes the image information, generates touch sense information of the image information, and supplies the touch sense information to the dot figure display main body 6 to display the touch sense information on the dot figure display screen of the pin matrix 3 as a dot figure. The control unit 15 fetches imaging signals of the video camera 10, and detects the position of the marker 12 touching the dot figure display screen of the pin matrix 3, i.e., a main finger tip touch position designated by the main finger tip 11 attached with the marker 12. The control unit further fetches outputs of the pressure sensors 8 (pressure sensors 8a to 8d), and periodically detects the pressure barycenter position 14 on the dot figure display screen of the pin matrix 3.

The control unit 15 detects a press force Ps at the pressure barycenter position 14 (the position of the marker 12 if a pressure is applied by only the main finger tip 11 attached with the marker 12) on the pin matrix 3, from the outputs of the pressure sensors 8a to 8d, and obtains a press state of the finger tips 11 and 11′ on the pin matrix 3, from the detected press force Ps. A presence/absence or intention (hereinafter called operator manipulation) of an operator pressing and operating the pin matrix 3 is recognized from the obtained press state. It is assumed herein that the press force Ps at the pressure barycenter position 14 is a sum of outputs A to D detected by the pressure sensors 8a to 8d shown in FIGS. 3A and 3B (i.e., Ps=A+B+C+D).

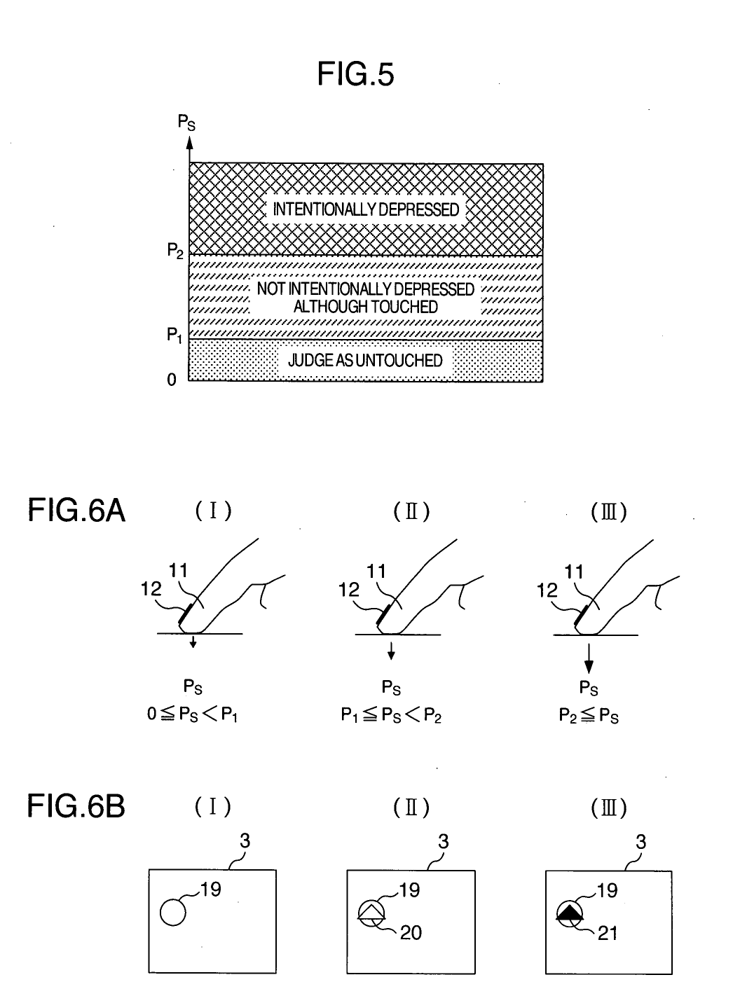

FIG. 5 is a diagram showing the relation between operator manipulation and a press force Ps at a detected pressure barycenter position 14.

Referring to FIG. 5, pressures P₁ and P₂ (P₁<P₂) are preset. The control unit 15 judges a press state, and performs a control operation in accordance with the judgement result. The control unit judges that both the finger tips 11 and 11′ do not touch the pin matrix 3 (non-press state) if 0≦Ps<P₁, that although at least both the finger tips 11 and 11′ touch the pin matrix 3 the pin matrix 3 is not depressed intentionally (weak press state) if P₁≦Ps<P₂, and that at least both the finger tips 11 and 1′ intentionally depress the pin matrix 3.

Reverting to FIG. 4A, each time the main finger tip and pressure barycenter position are detected, the control unit 15 detects a difference from the main finger tip and pressure barycenter position detected one cycle before to detect a change in the main finger tip and pressure barycenter position and a change in the pressures (press forces of the finger tips 11 and 11′) detected by the pressure sensors 8, reads image information from the storage unit 16 and generates touch sense information in accordance with the change in the main finger tip and pressure barycenter position and the change in the pressures detected by the pressure sensors 8, to thereby display the touch sense information on the dot figure display screen of the pin matrix 3. In this manner, the touch sense information displayed on the dot figure display screen can be changed by moving the main finger tip 11 and sub finger chip 11′ in a state that a pressure is applied to the dot figure display screen of the pin matrix 3, i.e., by manipulating the dot figure display screen of the pin matrix 3 with the main finger tip 11 and sub finger tip 11′.

Specific example shown in FIG. 4B shows the system configuration used by the apparatus connected to another apparatus such as an elevator operation unit and a car navigation operation unit. Although the fundamental configuration is the same as that of the specific example shown in FIG. 4A, the control unit 15 is connected to another function unit 18 via a connection unit 17. Control signals corresponding to manipulation of the main finger tip 11 and sub finger tip 11′ on the dot figure display panel of the pin matrix 3 are supplied to the other function unit 18 via the connection unit 17 to control the other function unit. The connection unit 17 may be a connection line, a network or the like, and the other function unit 18 may be a center of an elevator, a center of a navigation system.

FIGS. 6A and 6B are diagrams showing the relation between a finger tip press state and its recognition state on the pin matrix 3 obtained by the control unit 15 (FIGS. 4A and 4B) based on the settings of FIG. 5. (I), (II) and (III) in FIG. 6A show the finger tip press state on the pin matrix 3, and (I), (II) and (III) in FIG. 6B show the recognition result (main finger touch position and pressure barycenter position on the pin matrix 3) by the controller 15. A white circle mark 19 represents the main finger tip touch position detected by an output of the video camera 10, and this white circle mark is called a main finger tip touch position 19. A white triangle mark 20 represents the pressure barycenter position 14 detected by the outputs of the pressure sensors 8a to 8d when the press force Ps is P₁≦PS<P₂ (weak press state) shown in FIG. 5, and this white triangle mark 20 is called a weak press force pressure barycenter position 20. A black triangle mark 21 represents the pressure barycenter position 14 detected by the outputs of the pressure sensors 8a to 8d when the press force Ps is P₂≦Ps (strong press state) shown in FIG. 5, and this black triangle mark 21 is called a strong press force pressure barycenter position 21.

(I) in FIG. 6A indicates a state (non-press state) that the press force Ps by the main finger tip 11 is 0≦Ps<P₁. In this non-press state, the control unit 15 judges that the main finger tip 11 does not touch the pin matrix 3, even if the main finger tip touches the pin matrix 3. Upon this judgement, the control unit 15 recognizes only the main finger tip position 19 which is the position of the marker 12 on the main finger tip 11 represented by the white circle mark in (I) in FIG. 6B.

(II) in FIG. 6A indicates a state (weak press state) that the press force Ps by the main finger tip 11 is P₁≦PS<P₂. In this non-press state, the control unit 15 judges that the main finger tip 11 does not press intentionally the pin matrix 3, even if the main finger tip touches the pin matrix 3. Upon this judgement, the control unit 15 recognizes the weak press pressure barycenter position 20 represented by the white triangle mark shown in (II) in FIG. 6B. Also in this case, the main finger tip touch position 19 represented by the white circle mark is recognized.

(III) in FIG. 6A indicates a state (strong press state) that the press force Ps by the main finger tip 11 is P₂≦Ps. In this strong press state, the control unit 15 judges that the main finger tip 11 presses intentionally the pin matrix 3. Upon this judgement, the control unit 15 recognizes the strong press pressure barycenter position 21 represented by the black triangle mark 21 shown in (III) in FIG. 6B. Also in this case, the main finger tip touch position 19 represented by the white circle mark is recognized.

In this manner, in accordance with the press position and state of the main finger tip 11 on the pin matrix 3, the control unit 15 recognizes the main finger tip touch position, pressure barycenter position 14 and press state of the main finger tip 11 on the pin matrix 3, and performs a control operation to be described later in accordance with the recognition results.

Although FIGS. 6A and 6B illustrates the touch manipulation only by the main finger tip 11, if there is also a touch manipulation by the sub finger tip 11′, the main finger tip touch position 19 represented by the white circle mark, pressure barycenter position 20 represented by the white triangle mark, and strong press pressure barycenter position 21 represented by the black triangle mark are displayed at different positions.

Next, description will be made on how an operator manipulates the pin matrix 3 of the apparatus of the first embodiment using the system shown in FIG. 4A to display a dot figure.

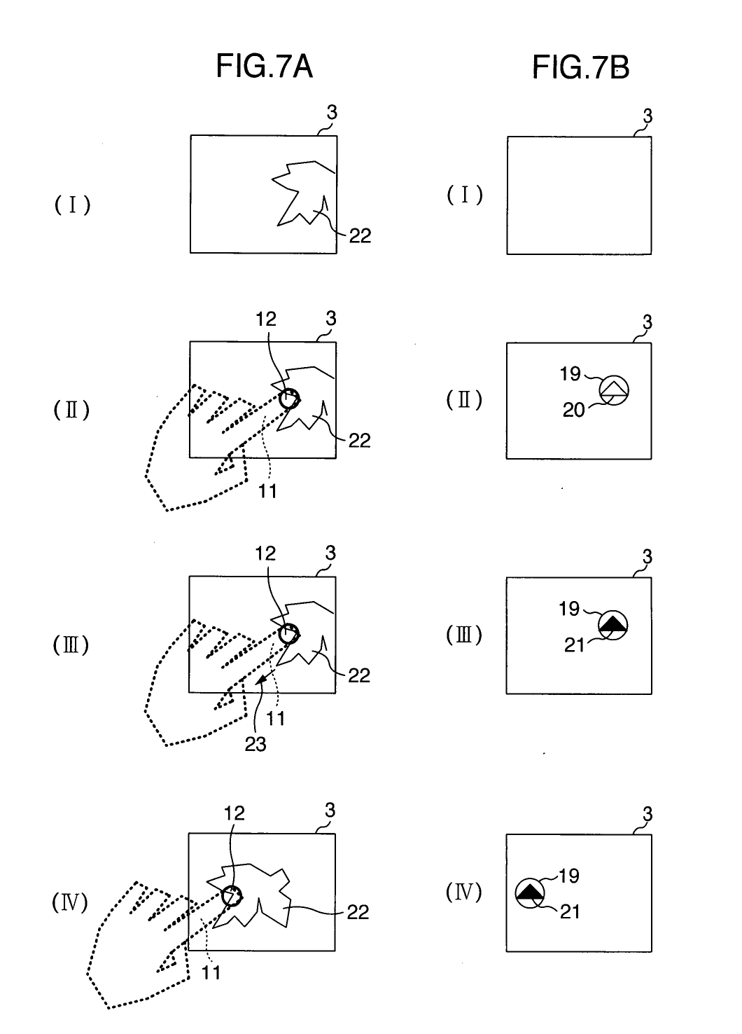

FIGS. 7A and 7B are diagrams showing a first example of a display state of a dot figure displayed by operator manipulation. FIG. 7A shows a change in the display state of a dot figure on the pin matrix 3, FIG. 7B shows a change in the position (main finger tip touch position) of the marker 12 on the pin matrix 3 detected by the video camera 10 and the pressure barycenter position 14 on the pin matrix obtained from outputs of the pressure sensors 8a to 8d, respectively effected by operator manipulation. Reference numeral 22 represents a dot figure, and reference numeral 23 represents an arrow indicating a slide direction. Elements corresponding to those shown in the above-described drawings are represented by identical reference symbols, and a duplicated description is omitted.

(I) in FIG. 7A displays the dot FIG. 22 on the pin matrix 3 and shows a state that a finger tip does not touch. In this case, as shown in (II) in FIG. 7B, the control unit 15 (FIG. 4A) recognizes neither the main finger tip touch position nor the pressure barycenter position 14. The contour of the dot FIG. 22 is drawn by projection pins 13b (FIGS. 2A to 2C), and other areas are drawn by non-projection pins 13a (FIGS. 2A to 2C). The operator can sense the dot FIG. 22 by touching the surface of the pin matrix 3 with a finger tip.

In this state, the operator touches the dot FIG. 22 with the main finger tip 11 to recognize the dot FIG. 22 as shown in (II) in FIG. 7A. In this case, the press force Ps of the main finger tip 11 is P₁≦Ps<P₂. The control unit recognizes the main finger tip touch position 19 (position of the marker 12) of the main finger tip 11 on the pin matrix 3 from an output of the video camera 10 as indicated by the white circle mark shown in (II) in FIG. 7B, the weak press pressure barycenter position 20 indicated by the white triangle mark from the outputs of the pressure sensors 8a to 8d, and the weak press state. In this case, the main finger tip touch position 19 is coincident with the weak press pressure barycenter position 20.

As the operator depresses the main finger tip 11 and the press force Ps becomes P₂≦Ps, the control unit 15 recognizes a strong press pressure barycenter position 21 represented by the black triangle mark and the strong press state, as shown in (III) in FIG. 7B. In this case, the main finger tip touch position 19 is coincident with the pressure barycenter position 21. The control unit 15 waits for the manipulation by the main finger tip 11. As shown in (III) in FIG. 7A, as the main finger tip 11 is slid, for example, along the direction indicated by the arrow 23 in the strong press state, the control unit 15 recognizes a motion (slide) of the main finger tip touch position 19 indicated by the white circle mark to the strong press pressure barycenter position 21 indicated by the black triangle mark as shown in (IV) in FIG. 7B, and sequentially reads image information on the dot FIG. 22 from the storage unit 16 upon this slide to change the display position on the pin matrix 3 to follow the motion on the pin matrix 3 and slide the dot FIG. 22 on the pin matrix 3 along the direction indicated by the arrow 23, as shown in (IV) in FIG. 7A. In this case, the main finger tip touch position 19 is coincident with the strong press pressure barycenter position 21.

As described above, as the operator touches the pin matrix 3 with the main finger tip 11, the main finger tip touch position 19 becomes coincident with the strong press pressure barycenter position 21, and as the operator slides the main finger tip 11 in the strong press state, the dot FIG. 22 displayed on the pin matrix 3 slides. It is therefore possible to conduct a slide operation on the pin matrix 3. If the first embodiment is the apparatus using the system shown in FIG. 4A, i.e., a stand-alone apparatus, the dot figure displayed on the pin matrix 3 can be displayed at the position desired by the operator. It is also possible that the control unit 15 makes each unit (not shown) of the apparatus perform an operation corresponding to the slide manipulation. If the first embodiment has the system shown in FIG. 4B, it is possible to make the other function unit 18 perform an operation corresponding to the slide manipulation.

Each pin of the pin matrix 3 has a thickness corresponding to one or a plurality of pixels on the imaging plane of the video camera 10, and a position of each pin of the pin matrix 3 corresponds to a pixel position of the imaging plane of the video camera 10. Therefore, a pixel position at the position (main finger tip touch position 19) of the marker 12 photographed with the video camera 10 can be made in correspondence with a position on the pin matrix 3. On the other hand, the pin positions included in a range of the dot FIG. 22 displayed on the pin matrix 3 can be made in correspondence with a range of the imaging plane of the video camera 10. Therefore, the control unit 15 converts a position of the marker on the imaging plane of the video camera 10 into the position on the pin matrix 3, for example, by forming a table storing a range of the dot FIG. 22 to be displayed on the pin matrix 3, so that it is possible to judge whether the marker is in the range of the dot FIG. 22 or the finger tip touches a pin in this range. It is obvious that this correspondence table is changed if the dot FIG. 22 displayed on the pin matrix 3 moves, for example, from (III) in FIG. 7A to (IV) in FIG. 7A or if the dot figure changes as in a specific example to be described later. Conversely, a correspondence table may be formed between a range of the dot FIG. 22 to be displayed on the pin matrix 3 and a range of the imaging plane of the video camera 10, to thereby judge whether the position of the marker 12 on the imaging plane photographed with the video camera 10 is in the range of the dot FIG. 22 or the finger tip touches a pin in this range.

Since the coordinate position (x, y) represented by the equations (1) and (2) represents the position on the pin matrix, the control unit 15 converts the pressure barycenter positions 20 and 21 into the positions on the imaging plane of the video camera 10 in accordance with the correspondence between the position on the pin matrix 3 and the position on the imaging plane of the video camera 10. It is therefore possible to judge from the correspondence table whether the pressure barycenter positions 20 and 21 are in the range of the dot FIG. 22 or the finger tip touches a pin in this range. This is also applied to specific examples to be described later.

The video camera 10 receives not only infrared rays reflected from the marker 12 but also infrared rays reflected from the surface of each pin of the pin matrix 3. A reflection amount of infrared rays from the marker 12 to the video camera 10 is very large as compared to the reflection amount of infrared rays from other areas to the video camera 10. Therefore, by detecting a level of an output of the video camera 10 by using a threshold value, it is possible to extract a signal corresponding to infrared rays reflected from the marker 12. This is also applied to specific examples to be described later.

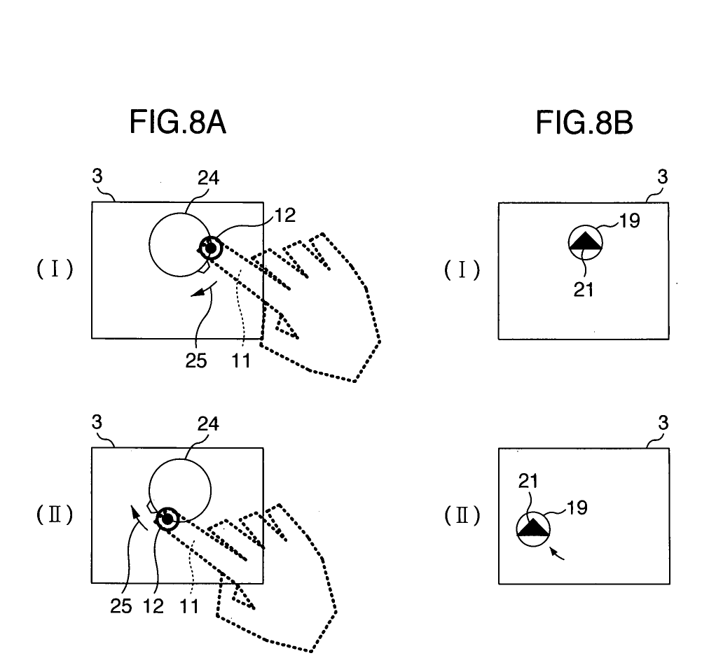

FIGS. 8A and 8B are diagrams showing a second example of a display state of a dot figure displayed by operator manipulation. FIG. 8A shows a change in the display state of a dot figure on the pin matrix 3 by operator manipulation, and FIG. 8B shows a change in the main finger tip touch position and pressure barycenter position 14 by operator manipulation. Reference numeral 24 represents a dot figure. Elements corresponding to those shown in the above-described drawings are represented by identical reference symbols, and a duplicated description is omitted.

(I) in FIG. 8A displays the dot FIG. 22 (in this example, a dial) on the pin matrix 3 and shows a state that the main finger tip 11 touches the edge of the dial 24 strongly at a press force Ps of P₂≦Ps. In this case, as shown (I) in FIG. 8B, the control unit 15 recognizes the main finger tip touch position 19 represented by the white circle mark, the strong press barycenter position 21 represented by the black triangle mark, and the strong press state. In this case, the main finger tip touch position is coincident with the press pressure barycenter position.

As the operator moves the main finger tip 11 in the direction indicated by an arrow 25 along the edge of the dial 24 (i.e., a rotation manipulation of rotating the dial 24), the control unit 15 recognizes a change (motion) in the main finger tip touch position 19 indicated by the white circle mark to the strong press pressure barycenter position 21 indicated by the black triangle mark as shown in (II) in FIG. 8B, and sequentially reads image information on the dial 24 from the storage unit 16 upon this motion to change the display position on the pin matrix 3 and rotate the dial 24 on the pin matrix 3, as shown in (II) in FIG. 8A. In this case, the main finger tip touch position 19 is coincident with the strong press pressure barycenter position 21.

As described above, in the second specific example, the operator touches the pin matrix 3 with only the main finger tip 11, as the main finger tip touch position becomes coincident with the press pressure barycenter position and the operator moves the main finger tip 11 along the circumference of the dial in the strong press state, the dial 24 displayed on the pin matrix 3 rotates. It is therefore possible to conduct a dial manipulation on the pin matrix 3. If the first embodiment is a stand-alone apparatus shown in FIG. 4A, it is possible that the control unit 15 makes each unit (not shown) of the apparatus perform an operation corresponding to the dial manipulation. If the first embodiment has the system shown in FIG. 4B, it is possible to make the other function unit 18 perform an operation corresponding to the dial manipulation. This rotation manipulation is not limited only to the dot figure of the dial 24.

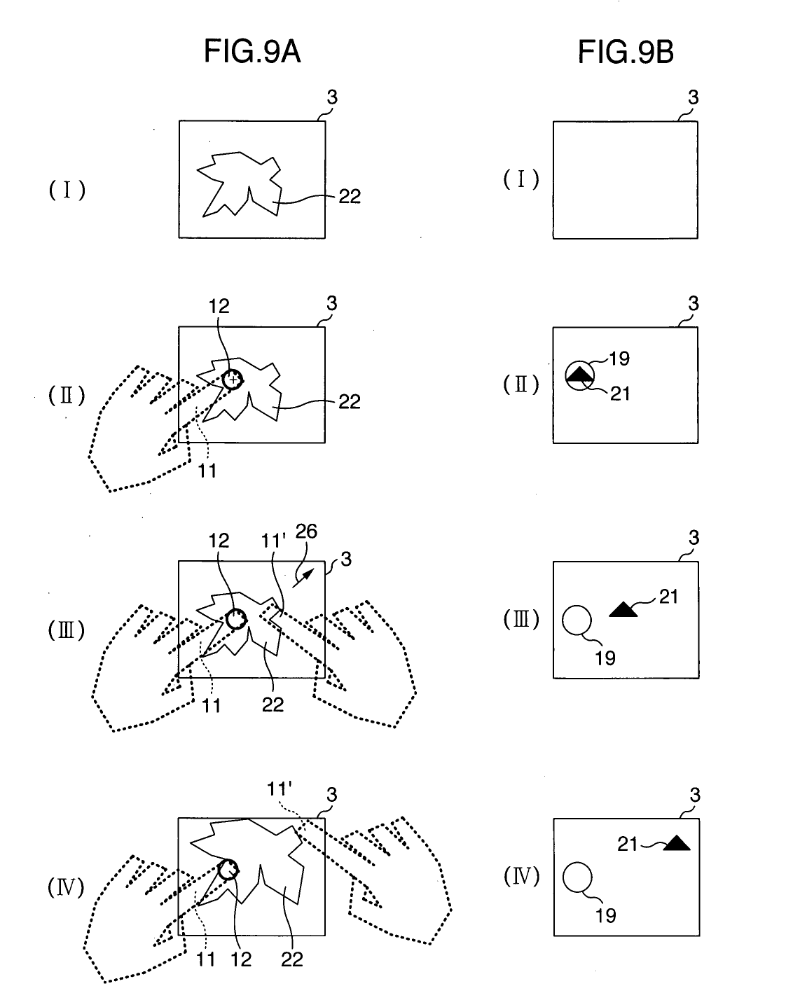

FIGS. 9A and 9B are diagrams showing a third example of a display state of a dot figure effected by operator manipulation. FIG. 9A shows a change in the display state of a dot figure on the pin matrix 3 by operator manipulation, and FIG. 9B shows a change in the main finger tip touch position and pressure barycenter position on the pin matrix 3 by operator manipulation. Elements corresponding to those shown in the above-described drawings are represented by identical reference symbols, and a duplicated description is omitted.

(I) in FIG. 9A displays the dot FIG. 22 on the pin matrix 3 and shows a state that a finger tip does not touch. In this case, as shown (I) in FIG. 9B, the control unit 15 (FIG. 4A) recognizes neither the main finger tip touch position nor the pressure barycenter position 14.

In this state, the operator depresses strongly the dot FIG. 22 with the main finger tip 11 to manipulate the dot FIG. 22 as shown in (II) in FIG. 9A. In this case, the press force Ps of the main finger tip 11 is P₂≦Ps. The control unit 15 recognizes the main finger tip touch position 19 (position of the marker 12) of the main finger tip 11 on the pin matrix 3 from an output of the video camera 10 as indicated by the white circle mark shown in (II) in FIG. 9B, the strong press pressure barycenter position 21 indicated by the black triangle mark from the outputs of the pressure sensors 8a to 8d, and the strong press state. In this case, the main finger tip touch position 19 is coincident with the strong press pressure barycenter position 21.

In this state, as shown in (III) in FIG. 9A, as a portion of the dot FIG. 22 is strongly depressed by another finger tip, i.e., the sub finger tip 11′, the pressure barycenter position detected by the pressure sensors 8a to 8d is at the position between the finger tips 11 and 11′. As the press force Ps by the finger tips 11 and 11′ becomes P₂≦Ps, as shown in (III) in FIG. 9B the control unit 15 recognizes that the strong press pressure barycenter position 21 represented by the black triangle mark is spaced from the main finger tip touch position 19 represented by the while circle mark, and also recognizes the strong press state.

Thereafter, as the sub finger tip 11′ is moved in a direction departing from the main finger tip 11 indicated by an arrow 26 without relaxing the press state while the main finger tip 11 is at a halt, as shown in (IV) in FIG. 9B the control unit 15 recognizes that a strong press pressure barycenter position 21 represented by the black triangle mark moves departing from the main finger tip touch position 19, and sequentially reads image information on the dot FIG. 22 from the storage unit 16 upon this motion and processes the image information in correspondence with this motion direction to display the processed image information on the pin matrix 3. Therefore, as shown in (IV) in FIG. 9A, the dot FIG. 22 changes its display state to sequentially enlarge the dot FIG. 22.

If the sub finger tip 11′ is at a halt and the main finger tip 11 is moved departing from the sub finger tip 11′, the dot FIG. 22 is also displayed sequentially being enlarged although the display position is different.

Conversely, if at least one of the main finger tip 11 and sub finger tip 11′ is moved to make the main finger tip 11 and sub finger tip 11′ come close to each other, the dot FIG. 22 displayed is sequentially reduced in size.

As described above, as the operator touches strongly the dot figure with the main finger tip 11 and sub finger tip 11′ and a distance between the finger tips 11 and 11′ is changed by moving at least one of the main finger tip 11 and sub finger tip 11′, the size of the displayed dot figure can be changed.

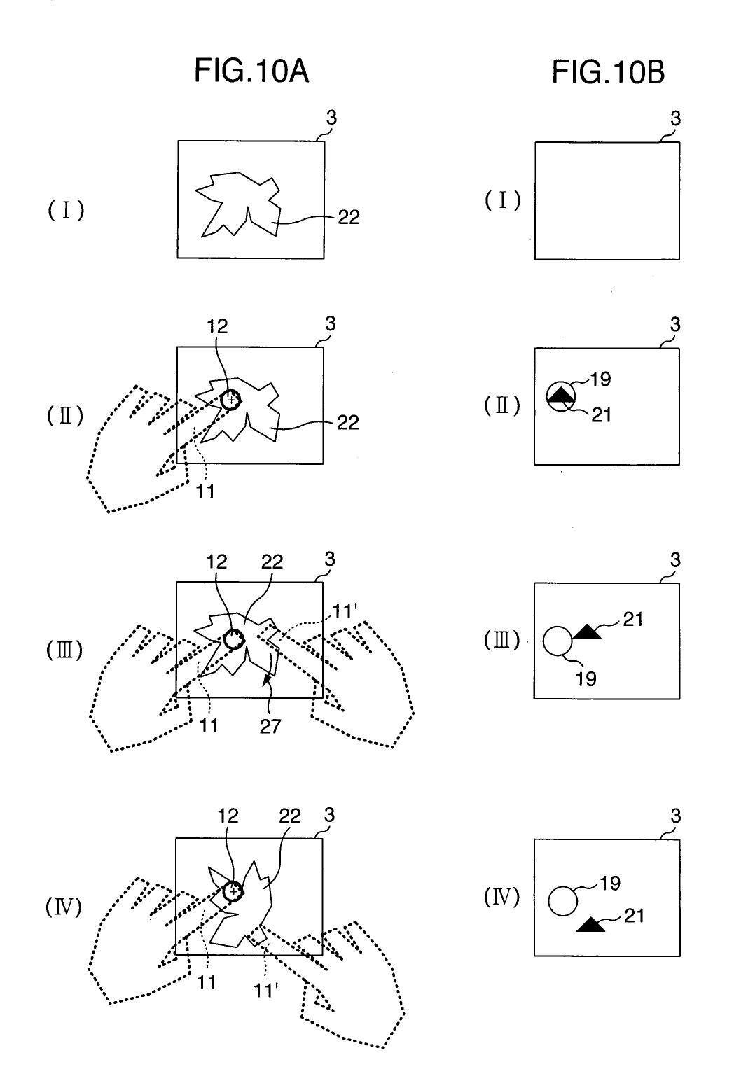

FIGS. 10A and 10B are diagrams showing a fourth example of a display state of a dot figure effected by operator manipulation. FIG. 10A shows a change in the display state of a dot figure on the pin matrix 3 by operator manipulation, and FIG. 10B shows a change in the main finger tip touch position and pressure barycenter position 14 on the pin matrix 3 by operator manipulation. Reference numeral 27 represents an arrow. Elements corresponding to those shown in the above-described drawings are represented by identical reference symbols, and a duplicated description is omitted.

(I) in FIG. 10A displays the dot FIG. 22 on the pin matrix 3 and shows a state that a finger tip does not touch. In this case, as shown (I) in FIG. 10B, the control unit 15 (FIG. 4A) recognizes neither the main finger tip touch position nor the pressure barycenter position.

In this state, the operator depresses strongly the dot FIG. 22 with the main finger tip 11 to manipulate the dot FIG. 22 as shown in (II) in FIG. 10A. In this case, the press force Ps of the main finger tip 11 is P₂≦Ps. The control unit 15 recognizes the main finger tip touch position 19 (position of the marker 12) of the main finger tip 11 on the pin matrix 3 from an output of the video camera 10 as indicated by the white circle mark shown in (II) in FIG. 10B, the strong press pressure barycenter position 21 indicated by the black triangle mark from the outputs of the pressure sensors 8a to 8d, and the strong press state. In this case, the main finger tip touch position 19 is coincident with the strong press pressure barycenter position 21.

In this state, as shown in (III) in FIG. 10A, as a portion of the dot FIG. 22 is strongly depressed by another finger tip, i.e., the sub finger tip 11′, the pressure barycenter position detected by the pressure sensors 8a to 8d is at the position between the finger tips 11 and 11′. As the press force Ps by the finger tips 11 and 11′ becomes P₂≦Ps, as shown in (III) in FIG. 10B the control unit 15 recognizes that the strong press pressure barycenter position 21 represented by the black triangle mark is spaced from the main finger tip touch position 19 represented by the while circle mark, and also recognizes the strong press state.

Thereafter, as the sub finger tip 11′ is moved rotatively around the main finger tip 11 in a direction indicated by the arrow 26 without relaxing the press state while the main finger tip 11 is at a halt, as shown in (IV) in FIG. 10B the control unit 15 recognizes that the strong press pressure barycenter position 21 represented by the black triangle mark moves rotatively around the main finger tip touch position 19, and sequentially reads image information on the dot FIG. 22 from the storage unit 16 upon this rotative motion and processes the image information in correspondence with this rotative motion direction to display the processed image information on the pin matrix 3. Therefore, as shown in (IV) in FIG. 10A, the dot FIG. 22 changes its display state to rotate by using the position (main finger tip touch position) where the main finger tip 11 is depressed, as its rotation center.

If the sub finger tip 11′ is at a halt and the main finger tip 11 is moved rotatively around the sub finger tip 11′, the dot FIG. 22 is also moved rotatively by using the sub finger tip 11′ as its rotation center.

As described above, as the operator touches strongly the dot figure with the main finger tip 11 and sub finger tip 11′ and at least one of the main finger tip 11 and sub finger tip 11′ is moved rotatively, the displayed dot figure can be rotated.

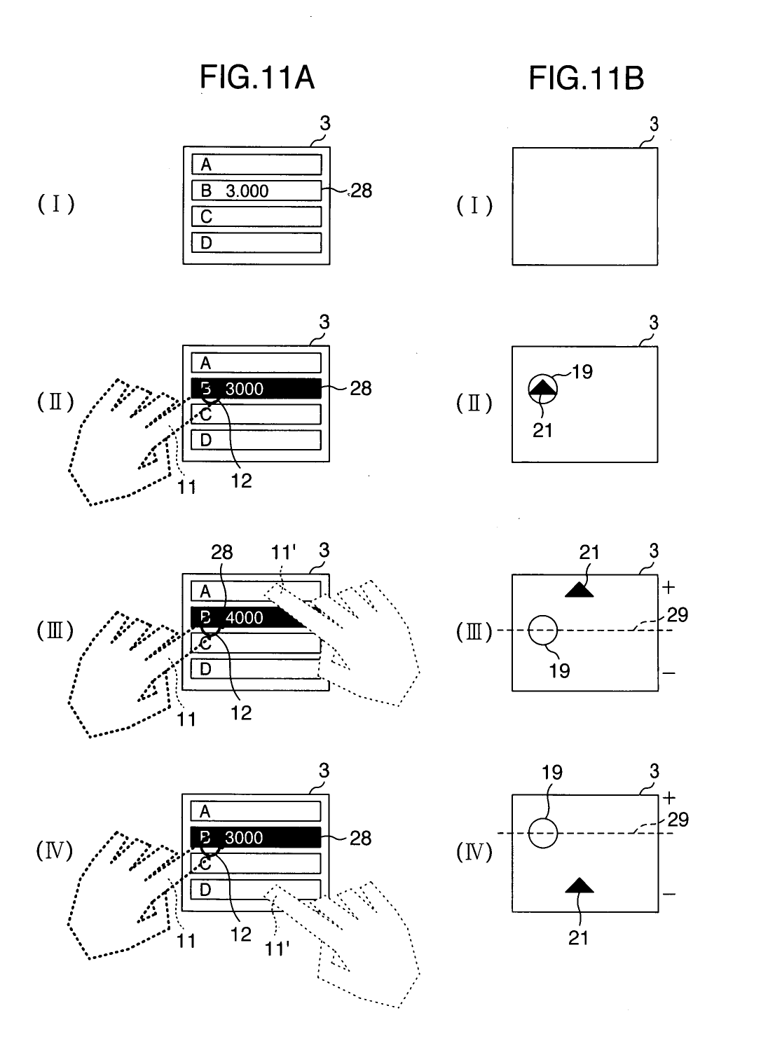

FIGS. 11A and 11B are diagrams showing a five example of a display state of a dot figure effected by operator manipulation. FIG. 11A shows a change in the display state of a dot figure on the pin matrix 3 by operator manipulation, and FIG. 11B shows a change in the main finger tip touch position and pressure barycenter position 14 on the pin matrix 3 by operator manipulation. Reference numeral 28 represents a numerical value display area, and reference numeral 29 represents an up/down area border line. Elements corresponding to those shown in the above-described drawings are represented by identical reference symbols, and a duplicated description is omitted.

(I) in FIG. 11A displays the dot FIG. 22 on the pin matrix 3 constituted of a plurality of numerical value areas: A, B, C, . . . fields in which numerical values are displayed. Description will be made herein on the assumption that a B field numerical value display area 28 is used as a manipulation target in which a numerical value of, e.g., “3000” is displayed. In this case, as shown in (II) in FIG. 11B, the control unit 15 (FIG. 4A) recognizes neither the main finger tip touch position nor the pressure barycenter position.

In this state, for example, the operator touches the numerical value display area 28 with the main finger tip 11 to confirm the numerical value displayed therein. Thereafter, the operator depresses strongly the numerical value area 28 with the main finger tip 11 to manipulate and change the numerical value in the numerical value display area 28, as shown in (II) in FIG. 11A. In this case, the press force Ps of the main finger tip 11 is P₂≦Ps. The control unit 15 recognizes the main finger tip touch position 19 (position of the marker 12) of the main finger tip 11 on the pin matrix 3 from an output of the video camera 10 as indicated by the white circle mark shown in (II) in FIG. 11B, the strong press pressure barycenter position 21 indicated by the black triangle mark from the outputs of the pressure sensors 8a to 8d, and the strong press state. In this case, the main finger tip touch position 19 is coincident with the strong press pressure barycenter position.

In this state, as shown in (III) in FIG. 11A, as a portion upper than the numerical value display area 28 on the pin matrix 3 is strongly depressed by another finger tip, i.e., the sub finger tip 11′, the pressure barycenter position detected by the outputs of the pressure sensors 8a to 8d moves to the position between the finger tips 11 and 11′. As the press force Ps by the finger tips 11 and 11′ becomes P₂≦Ps, as shown in (III) in FIG. 11B the control unit 15 recognizes the strong press pressure barycenter position 21 represented by the black triangle mark spaced from the main finger tip touch position 19 represented by the while circle mark, and also recognizes the strong press state.

In this specific example, as shown in (III) in FIG. 11B, the up/down area border line 29 passing through the white circle mark 19 is set parallel to the horizontal axis of the pin matrix 3. The control unit 15 judges whether the strong press pressure barycenter position 21 represented by the black triangle mark is upper or lower than the up/down area border line 29. In this case, since the strong press pressure barycenter position 21 represented by the black triangle mark is upper than the up/down area border line 29, the control unit 15 judging this increments the numerical value displayed in the numerical value display area 28 by a predetermined value, as shown in (III) in FIG. 11A. An increment of this numerical value is effected each time the sub finger tip 11′ is strongly depressed to obtain the press force Ps of P₂≦Ps. In this example, each time this depression is effected, the numerical value is incremented by “1000”.

In the state of (II) in FIG. 11A, as shown in (IV) in FIG. 11A, as a portion lower than the numerical value display area 28 on the pin matrix 3 is strongly depressed by the sub finger tip 11′, the pressure barycenter position detected by the outputs of the pressure sensors 8a to 8d moves to the position between the finger tips 11 and 11′. As the press force Ps by the finger tips 11 and 11′ becomes P₂≦Ps, as shown in (IV) in FIG. 11B, the control unit 15 recognizes the strong press pressure barycenter position 21 represented by the black triangle mark spaced from the main finger tip touch position 19 represented by the while circle mark, and also recognizes the strong press state.

In this case, since the strong press pressure barycenter position 21 represented by the black triangle mark is lower than the up/down area border line 29, the control unit 15 judging this decrements the numerical value displayed in the numerical value display area 28 by a predetermined value, as shown in (IV) in FIG. 11A. A decrement of this numerical value is effected each time the sub finger tip 11′ is strongly depressed to obtain the press force PS of P₂≦Ps. Also in this example, each time this depression is effected, the numerical value is decremented by “1000”.

The first embodiment using the fifth example of the display state may be applied, for example, to an apparatus for paying and receiving money such as an automatic teller machine (ATM).

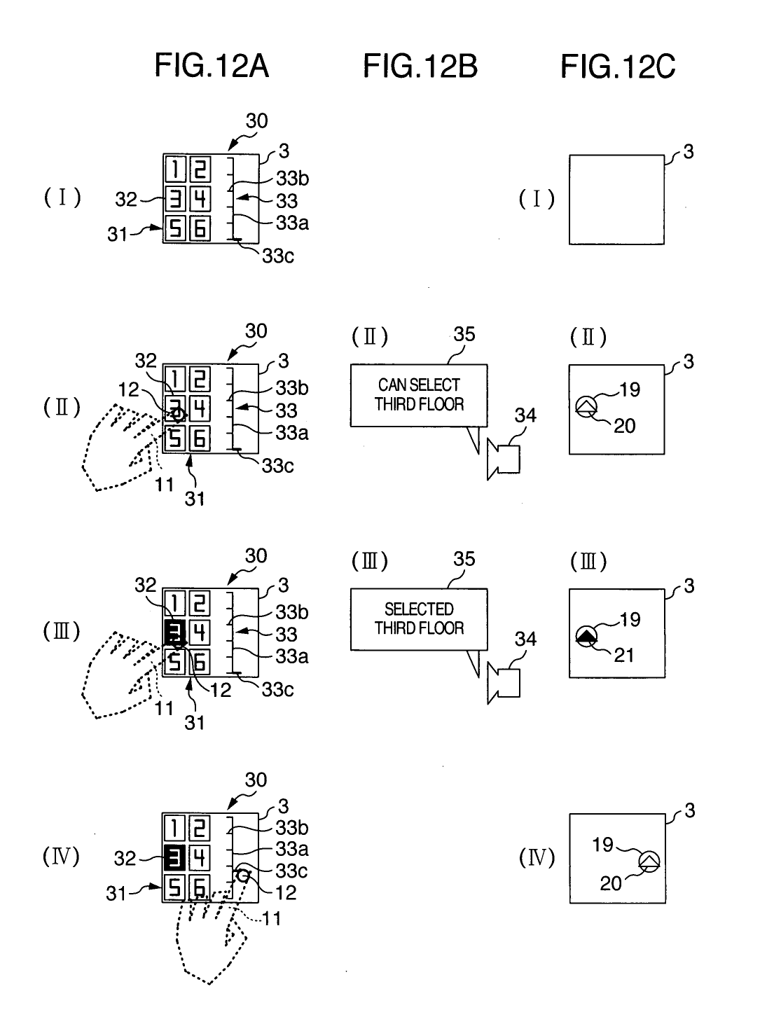

FIGS. 12A to 12C are diagrams showing a sixth example of a display state of a dot figure on the pin matrix effected by operator manipulation of an elevator operation unit. FIG. 12A shows a change in the display state of a floor select unit constituted of a dot figure on the pin matrix 3 by operator manipulation, FIG. 12B shows a voice output corresponding to a manipulation of the floor select unit, and FIG. 12C shows a change in the main finger tip touch position and pressure barycenter position on the pin matrix 3 by operator manipulation. In FIGS. 12A to 12C, reference numeral 30 represents an elevator operation unit, reference numeral 31 represents a floor select unit, reference numeral 32 represents a floor select button, reference numeral 33 represents an elevator position display unit, reference symbol 33a represents a vertical bar, reference symbol 33b represents a floor bar, reference symbol 33c represents a position bar, reference numeral 34 represents a speaker, and reference numeral 35 represents a voice message. Elements corresponding to those shown in the above-described drawings are represented by identical reference symbols, and a duplicated description is omitted.

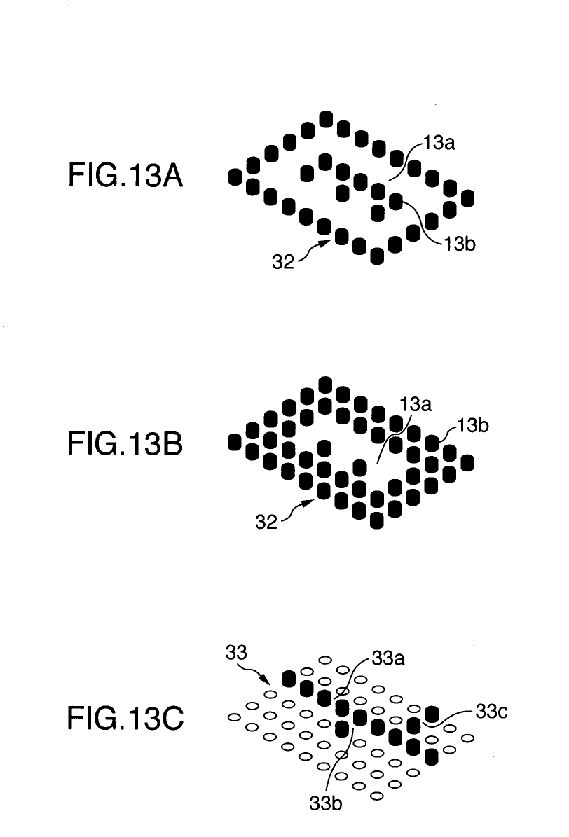

FIGS. 13A to 13C are enlarged diagrams showing the main portion of the elevator operation unit shown in FIGS. 12A to 12C. Elements corresponding to those shown in FIGS. 12A to 12C and FIGS. 1A and 1B are represented by identical reference symbols, and a duplicated description is omitted.

(I) in FIG. 12A shows a display state of the elevator operation unit 30 displayed by the dot figure on the pin matrix 3. The elevator operation unit 30 has a structure provided with the floor select unit 31 constituted of a plurality of floor select buttons 32 for selecting each floor (in this example, first to sixth floors) and the elevator position display unit 33 for displaying a present position of the elevator, respectively displayed by the dot figure. The elevator position display unit 33 has: the vertical bar 33a disposed in a height direction; the floor bar 33b constituted of one or a plurality of projection pins 13b (FIGS. 2A to 2C) disposed in a horizontal direction, formed on the vertical bar 33a and showing each floor; and the position bar 33c constituted of one or a plurality of projection pins 13b (FIGS. 2A to 2C) disposed in a horizontal direction, showing a present position of the elevator and being capable of moving along the vertical bar 33a to follow the up/down motion of the elevator, respectively displayed by the dot figure.

FIG. 13A shows enlarged views of the floor select buttons 32 in a non-manipulation state. A numerical value (in this example, “3”) representative of the floor and a frame of the floor select button are made of projection pins 13b, and the other portions are made of non-projection pins.

The state in (I) in FIG. 12A is a state that a finger tip does not touch the pin matrix 3. In this case, as shown (I) in FIG. 12C, the control unit 15 (FIG. 4A) recognizes neither the main finger tip touch position nor the pressure barycenter position.

In this state, as shown in (II) in FIG. 12A, the operator touches the floor select unit 31 of the elevator operation unit 30 with the main finger tip 11 to confirm the floor select button 32 of each floor. If the press force Ps is P₁≦Ps<P₂ (i.e., depression in the weak press state), the control unit 15 recognizes the main finger tip touch position 19 (position of the marker 12) of the main finger tip 11 on the pin matrix 3 as indicated by the white circle mark shown in (II) in FIG. 12C, the weak press pressure barycenter position 20 indicated by the black triangle mark from the outputs of the pressure sensors 8a to 8d, and the weak press state. In this case, the main finger tip touch position 19 is coincident with the weak press pressure barycenter position 20. Also in this case, the first embodiment has a built-in voice processing unit and the built-in speaker 34 as its output unit. As the main finger tip 11 depresses the floor select button 32 in the weak press state, the control unit 15 makes during this depression period the speaker output the voice message 35 such as “can select third floor”.

As the operator confirms the floor select button 32 of a desired floor (e.g., third floor) and strongly depresses the third floor select button 32 with the finger tip 11, the press force Ps becomes P₂≦Ps. In this case, as shown in (III) in FIG. 12C, the control unit 15 recognizes the main finger tip touch position 19 (position of the marker 12) of the main finger tip 11 on the pin matrix 3 from the output of the video camera 10 as indicated by the white circle mark shown in (III) in FIG. 12C, the strong press pressure barycenter position 21 indicated by the black triangle mark from the outputs of the pressure sensors 8a to 8d, and the strong press state. In this case, the main finger tip touch position 19 is coincident with the strong press pressure barycenter position 21.

As shown in (III) in FIG. 12A, the control unit 15 changes the display state of the selected third floor select button 32 to a pin projection/non-projection revered state. FIG. 13B shows the pin projection/non-projection revered state. The projection pins 13b in FIG. 13A showing the enlarged view of the floor select button 32 shown in (II) in FIG. 12A are changed to the non-projection pins 13a, and the non-projection pins 13a are changed to the projection pins 13b. Therefore, the numerical value “3” representative of the third floor indicated by the projection pins 13b in (II) in FIG. 12A and in (I) in FIG. 13A is displayed by the non-projection pins 13a in (III) in FIG. 12A and FIG. 13B through projection/non-projection reversal. The frame of the floor select button 32 is displayed always by the projection pins 13b.

As the floor select button 32 is selected, the floor select button 32 continues to be displayed in the projection/non-projection reversal state until the elevator reaches the selected third floor. When the elevator reaches the third floor, selection of the floor select button 32 is released to resume the display state shown in (II) in FIG. 12A and FIG. 13A.

As the floor select button 32 is selected, the control unit 15 makes the speaker 34 output a voice message 35 such as “selected third floor”.

As described above, the operator can select easily a desired floor without involving visual sense. The floor select button once selected is maintained in the selected state of easy touch sense until the floor selection is released. It is therefore possible to easily confirm the selection.

Further, as described above, as the third floor select button 32 is selected and the elevator moves up or down, the position bar 33c of the elevator position display unit 33 moves up or down along the vertical bar 33a as shown in (IV) in FIG. 12A. FIG. 13C is an enlarged view of the elevator position display unit 33. In this case, the vertical bar 33a, floor bar 33b and position bar 33c are displayed by the projection pins 13b and the other areas are displayed by the non-projection pins 13a. In accordance with motion information on the elevator supplied from an elevator drive apparatus (e.g., the other function unit 18 shown in FIG. 4B), the control unit 15 sequentially uses a set of one or a plurality of pins of each position bar 33c to thereby allow a motion of the position bar 33c along the vertical bar 33a. The operator can know the position of the elevator through touch sense by touching the elevator position display unit 33 with any one of finger tips.

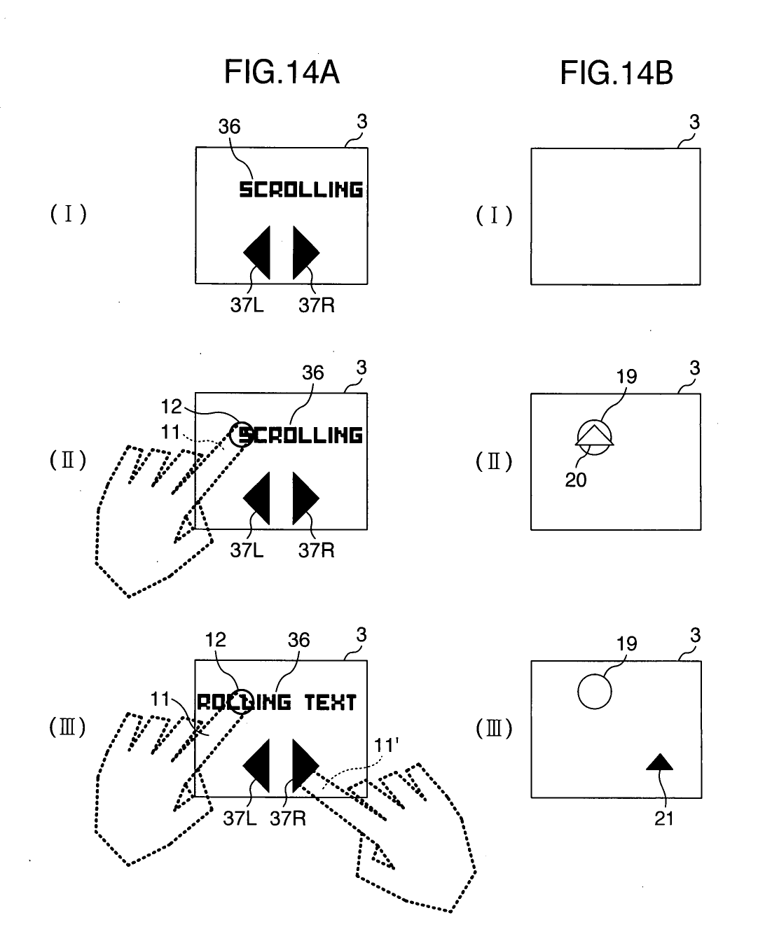

FIGS. 14A and 14B are diagrams showing a seventh example of a display state of a dot figure capable of scrolling a text by operator manipulation. FIG. 14A shows a change in the display state of a dot figure on the pin matrix 3, and FIG. 14B shows a change in the dot figure on the pin matrix 3 by operator manipulation. Reference numeral 36 represents a text, reference symbol 37L represents a left scroll button, and reference symbol 37R is a right scroll button. Elements corresponding to those shown in the above-described drawings are represented by identical reference symbols, and a duplicated description is omitted.

(I) in FIG. 14A displays a text 36 on the pin matrix 3 indicated by the dot figure by making the control unit 15 read text information from the storage unit 16, and shows a state that a finger tip does not touch. In this case, as shown (I) in FIG. 14B, the control unit 15 (FIG. 4A) recognizes neither the main finger tip touch position nor the pressure barycenter position 14. The left scroll button 37L and right scroll button 37R for scrolling the text 36 in the left and right direction are displayed on the pin matrix 3 by the dot figure of the projection pins 13b (FIGS. 2A to 2C). The scroll buttons can be distinguished by their shape and direction through touch sense.

In this state, as shown in (II) in FIG. 14A, the operator can know the characters of the text 36 by touching the text with the main finger tip 11. As the main finger tip 11 is moved along the text 36, the text 36 displayed on the pin matrix 3 can be read.

In this case, since only reading the text 36 is to be performed, the main finger tip 11 depresses weakly the dot figure of the text 36. The press force Ps by the main finger tip 11 is P₁≦Ps<P₂. As shown in (II) in FIG. 14B, the control unit 15 recognizes the main finger tip touch position 19 (position of the marker 12) of the main finger tip 11 on the pin matrix 3 from an output of the video camera 10 as indicated by the white circle mark, the weak press pressure barycenter position 20 indicated by the black triangle mark from the outputs of the pressure sensors 8a to 8d, and the weak press state. In this case, the main finger tip touch position 19 is coincident with the weak press pressure barycenter position 20.

In this state, as shown in (III) in FIG. 14A, as the right scroll button 37R is depressed strongly, for example, with the sub finger tip 11′, the press force Ps of the finger tips 11 and 11′ becomes P2₁≦Ps and the control unit 15 recognizes that the strong press pressure barycenter position 21 indicated by the black triangle mark spaced from the main finger tip touch position 19 (indicated by the white circle mark, as indicated in (III) in FIG. 14B and also recognizes the strong press state.

As the sub finger tip 11′ depresses the right scroll button 37R in the strong press state, the control unit 15 judges that the strong press pressure barycenter position 21 indicated by the black triangle mark shown in (III) in FIG. 14B is at the position corresponding to the position of the right scroll button 37R. The control unit 15 sequentially reads text information from the storage unit 16 and displays the text information on the pin matrix 3 so long as the right scroll button 37R is manipulated. Therefore, the text 36 is scrolled in the left direction to sequentially display a new character from the right side. Therefore, the text 36 can be sequentially sensed and read only by touching the text 36 with the main finger tip 11.

As the left scroll button 37L is depressed with the sub finger tip 11′ in the strong press state in the manner described above, the text 36 scrolls in the left direction. It is therefore possible to return the text 36 to the front portion.

A scroll speed may be made variable in accordance with the intensity of the press force (however, P₂≦Ps).

In reading the text 36, the sub finger tip 11′ may be used, and the main finger tip 11 is used for manipulating the right scroll button 37R and left scroll button 37L. In this case, the control unit 15 judges from the position of the marker 12 of the main finger tip 11, i.e., the main finger tip touch position 19 whether the right scroll button 37R or left scroll button 37L is manipulated.

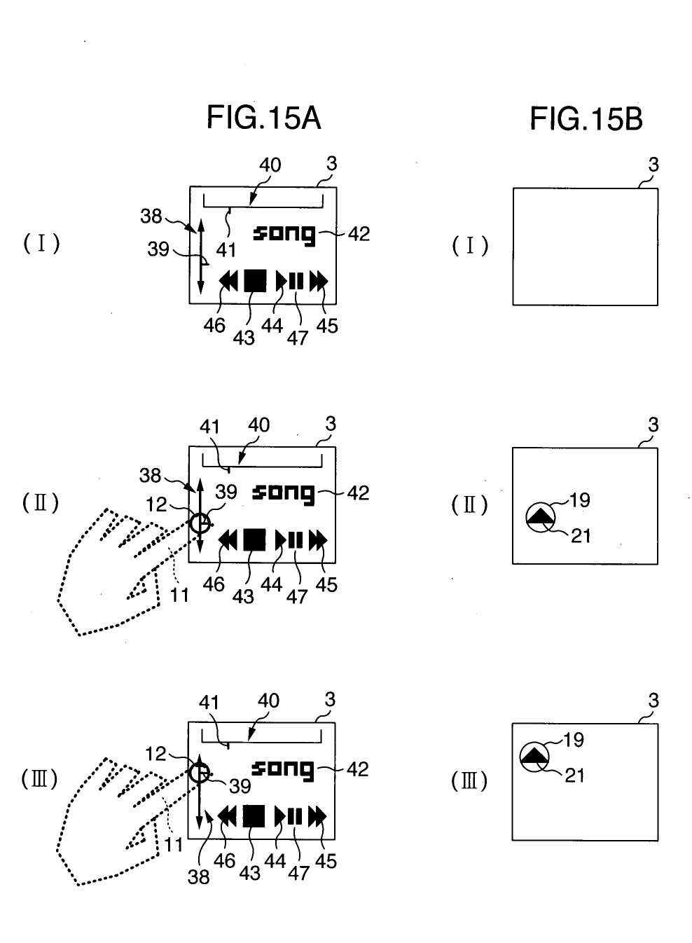

FIGS. 15A and 15B are diagrams showing an eighth example of a display state of a dot figure on the pin matrix made by operator manipulation when the first embodiment is applied to an operation unit of a voice reproducing apparatus. FIG. 15A shows a change in the display state of a dot figure on the pin matrix 3 by operator manipulation, and FIG. 15B shows a change in the main finger tip touch position and pressure barycenter position on the pin matrix 3 by operator manipulation. Reference numeral 38 represents a volume adjusting unit, reference numeral 39 represents a volume adjusting bar, reference numeral 40 represents a progress state display unit, reference numeral 41 represents a progress state display bar, reference numeral 42 represents a title, reference numeral 43 represents a stop button, reference numeral 44 represents a play button, reference numeral 45 represents a rewind button, reference numeral 46 represents a fast feed button, and reference numeral 47 represents a temporary stop button. Elements corresponding to those shown in the above-described drawings are represented by identical reference symbols, and a duplicated description is omitted.

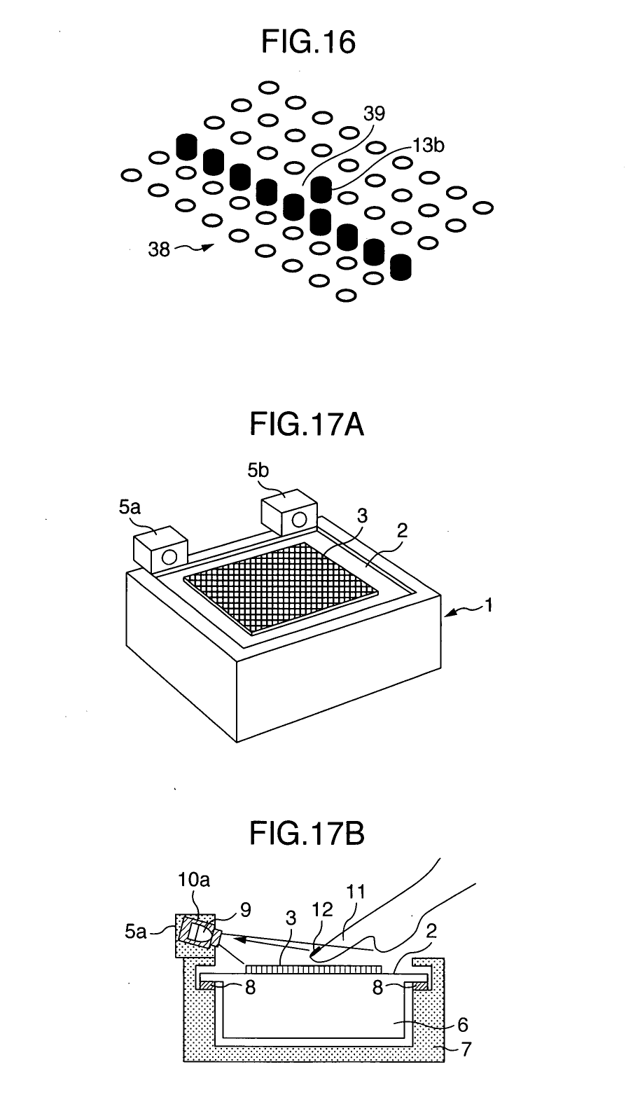

FIG. 16 is an enlarged diagram showing the main portion of the volume adjusting unit shown in FIGS. 15A and 15B. Elements corresponding to those shown in the above-described drawings are represented by identical reference symbols, and a duplicated description is omitted.

(I) in FIG. 15A shows a display state of the operation unit 30 displayed as the dot figure on the pin matrix 3 by making the control unit 15 read the screen of the operation unit from the storage unit 16. Displayed in the operation unit as the dot figure are the title of 42 of, e.g, music, the stop button 43, play button 44, rewind button 45, fast feed button 46, temporary stop button 47, volume adjusting unit 38 and progress state display unit 40. These operation buttons 43 to 47 can be distinguished by their shape and direction through touch sense.

The volume adjusting unit 38 is provided with the volume adjusting bar 39. By moving the volume adjusting bar 39, a volume of sounds of reproduced music or the like can be adjusted. The progress state display unit 40 is provided with the progress state display bar 41. The progress state display bar 41 moves as the sound reproduction progresses to display a sound reproduction progress state.

In the state in (I) in FIG. 15A, the control unit 15 (FIG. 4A) recognizes neither the main finger tip touch position nor the pressure barycenter position, as shown in (I) in FIG. 15B.

In the reproduction state, as shown in (II) in FIG. 15A as the operator strongly depresses a portion of the volume adjusting bar 39 of the volume adjusting unit 38 with the main finger tip 11 and the press force Ps becomes P₂≦Ps, the control unit 15 recognizes the main finger tip touch position 19 as indicated by the white circle mark shown in (II) in FIG. 15B, the strong press pressure barycenter position 21 indicated by the black triangle mark from the outputs of the pressure sensors 8a to 8d, and the strong press state. In this case, the main finger tip touch position 19 is coincident with the strong press pressure barycenter position 21.

In the strong press state, as the main finger tip 11 is moved along the volume adjusting unit 38 as shown in (III) in FIG. 15A, the control unit 15 recognizes a motion of the main finger tip touch position 19 indicated by the white circle mark and the strong press pressure barycenter position 21 indicated by the black triangle mark, and changes the volume while the volume adjusting bar 39 is moved together with the main finger tip 11.

Similar to the elevator position display unit 33 shown in FIG. 13C, the volume adjusting unit 38 is displayed by the projection pins 13b as shown in FIG. 16. The volume adjusting bar 39 is made of a set of one or a plurality of pins. In accordance with a motion of the main finger tip touch position 19 indicated by the white circle mark and the strong press pressure barycenter position 21 indicated by the black triangle mark, the control unit 15 sequentially uses a set of one or a plurality of pins of the volume adjusting bar 39. Therefore, as the operator strongly depresses the volume adjusting bar 39 and moves the bar with the main finger tip 11, the volume can be adjusted while the volume adjusting bar 39 moves.

As described above, the position of the volume adjusting bar 39 can be known through touch sense, and the present volume can be recognized and adjusted.

As described above, the first embodiment has detecting means (video camera 10 and pressure sensors 8a to 8d) for detecting a position (main finger tip touche position) of the marker 12 made of recursive reflection material on the pin matrix 3. The control unit judges the manipulation state of the dot figure displayed on the pin matrix 3 in accordance with the detected main finger tip touch position, pressure barycenter position and press state to manipulate the dot figure displayed on the pin matrix 3. Accordingly, it is possible to easily and reliably perform a desired manipulation of the pin matrix 3 only by touch sense of a finger tip, not depending upon visual sense.

For manipulation without involving visual sense, the operation screen (dot figure display screen) is confirmed often not only by the main finger tip, but also by the sub finger tip and another finger tip. In this embodiment, an operation corresponding to the position of the main finger tip and the barycenter position of a press point is performed without performing an operation corresponding to an initially touched position as in the case of a usual touch panel. An operator can therefore confirm the display contents by touching the operation panel freely and confidently.

FIGS. 17A and 17B are schematic diagrams showing the structure of a dot figure display apparatus according to the second embodiment of the present invention. FIG. 17A is a schematic outer perspective view showing the overall structure of the dot figure display apparatus, and FIG. 17B is a vertical cross sectional view of FIG. 17A. Reference symbols 5a and 5b represent holders, and reference symbol 10a represents a video camera. Elements corresponding to those shown in FIGS. 1A and 1B are represented by identical reference symbols, and a duplicated description is omitted.

Referring to FIGS. 17A and 17B, two holders 5a and 5b are mounted spaced apart from each other on one side of an upper surface of the apparatus 1. Each of the holders 5a and 5b has a video camera and one or a plurality of infrared LEDs respectively built therein. FIG. 17B is a cross sectional view showing the cross section on the holder 5a side in which a the video camera 10a and infrared LED 9 are held in the holder 5a.

Each of the infrared LEDs 9 in the holders 5a and 5b irradiates downward obliquely infrared rays to the whole area of the pin matrix 3. If a marker 12 made of recursive reflection material and attached to the main finger tip 11 exists on the pin matrix 3, the video camera 10a in the holder 5a and the video camera in the holder 5b receives infrared rays reflected from the marker 12 to form images. The position of the marker 12 on the pin matrix 3 is detected from the photographed results of the two video cameras.

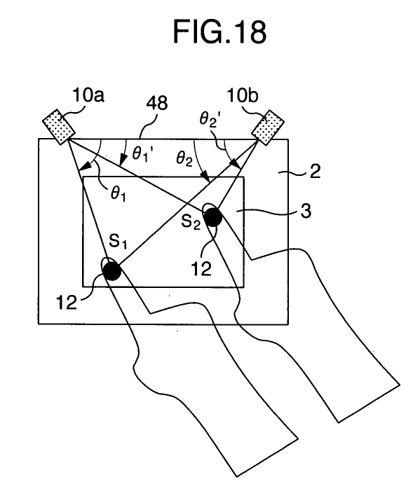

FIG. 18 is a diagram illustrating a method of detecting the position (i.e., main finger tip touch position) of the marker 12 in the second embodiment shown in FIGS. 17A and 17B. Reference symbol 10b represents the video camera held in the holder 5b, and reference numeral 48 represents a base line. Elements corresponding to those shown in the above-described drawings are represented by identical reference symbols, and a duplicated description is omitted.

Referring to FIG. 18, it is assumed that the marker 12 made of recursive reflection material is positioned at a point S₁ on the pin matrix 3. Infrared rays are irradiated from the infrared LED 9 disposed near the video camera 10a, and infrared rays reflected from the marker 12 are received by the video camera 10a to thereby detect a reception direction of infrared rays, i.e., a direction of the marker 12 as the point S₁. This direction is expressed by an angle θ₁ between the base line 40 and the optical axis of infrared rays received by the video camera 10a, the base line 40 being a straight line coupling the centers of the imaging planes of the two video cameras 10a and 10b. Similarly, infrared rays are irradiated from the infrared LED 9 disposed near the video camera 10b, and infrared rays reflected from the marker 12 are received by the video camera 10b to thereby detect a reception direction of infrared rays, i.e., a direction of the marker 12 as the point S₁. This direction is expressed by an angle θ₂ between the base line 40 and the optical axis of infrared rays received by the video camera 10b. Therefore, the position of the marker 12, i.e., the S₁ point is expressed by an angular coordinate (θ₁, θ₂).

Similarly, if the maker 12 is positioned at a point S₂ on the pin matrix 3, the video camera 10a detects the direction of the marker 12 as an angle θ₁′ and the video camera 10b detects the direction of the marker 12 as an angle θ₂′. Therefore, the position of the maker 12 is expressed by an angular coordinate (θ₁′, θ₂′).

The detected angular coordinate of the marker changes with the position of the marker 12 on the pin matrix 12, and the angular coordinate and the position on the pin matrix 3 is in one-to-one correspondence. The control unit 15 has a correspondence table between the angular coordinate and the position on the pin matrix 3, and by using this table, converts the angular coordinate detected from outputs of the video cameras 10a and 10b into the position on the pin matrix 3. It can therefore judge from the correspondence table whether the marker 12 is in a range of the dot figure displayed on the pin matrix 3.

The configuration other than the above-described configuration is similar to that of the first embodiment described with reference to FIGS. 1A to 16, and advantages similar to those of the first embodiment can be obtained.

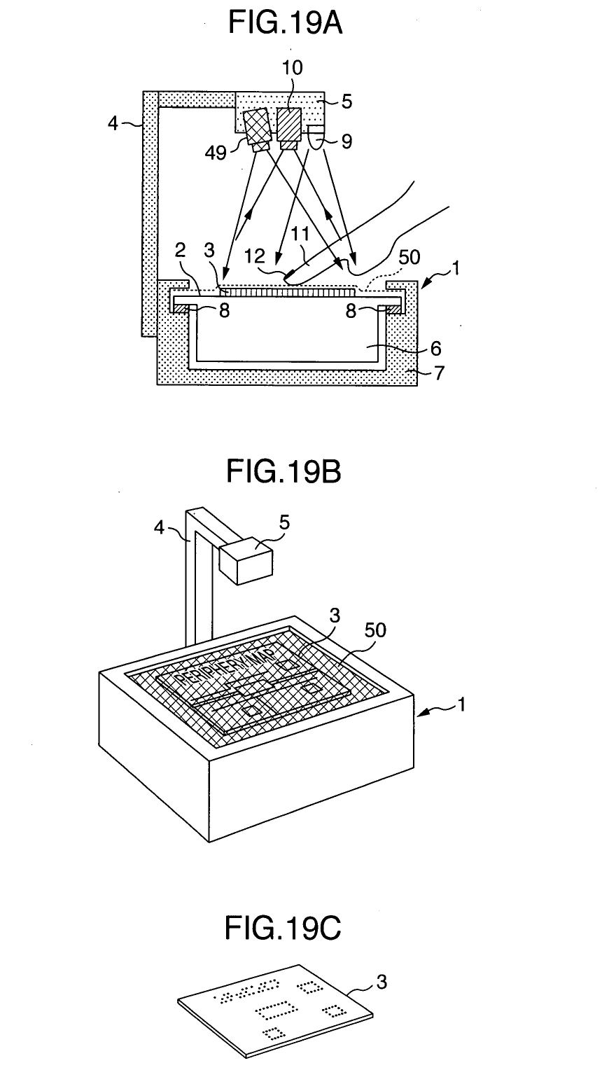

FIGS. 19A to 19C are schematic diagrams showing the structure of a dot figure display apparatus according to the third embodiment of the present invention. FIG. 19A is a vertical cross sectional view, FIG. 19B is a perspective view showing the display state on the screen, and FIG. 19C is a diagram showing the display state of the pin matrix. Reference numeral 49 represents a projector, and reference numeral 50 represents a projector screen. Elements corresponding to those shown in FIGS. 1A and 1B are represented by identical reference symbols, and a duplicated description is omitted.

Referring to FIG. 19A, a holder 5 supported by a support unit 4 holds a video camera 10 and one or a plurality of infrared LEDs 9 as well as the projector 49. The projector screen 50 is mounted on a display unit 6 of a dot figure display main body 6, covering the whole of at least the pin matrix 3. This projector screen 10 is a cover made of material rich in flexibility such as cloth and stocking material. As shown in FIG. 19C, the displayed dot figure on the pin matrix 3 just under the projector screen 50 can be touched with a finger tip via the projector screen.

As shown in FIG. 19A, the projector 49 mounted on the holder 5 is used for displaying characters, figures, maps, images and the like on the projector screen 50. If the dot figure on the pin matrix 3 displays touch buttons in the specific examples previously described with FIGS. 11A to 16, a character string representative of the type of each touch button displayed as a dot figure can be displayed. In this case, the type of a touch button can also be recognized by visual sense. Such characters as well as figures (e.g., the above-described elevator operation unit and the like), maps (particularly in the case of a car navigation apparatus), images and the like may be projected at the same time on the projector screen 50. A character string not pertaining to the dot figure displayed on the pin matrix 3 may be displayed. A contour of a dot figure displayed on the pin matrix may be displayed.

The other configuration is similar to that of the first embodiment described with reference to FIGS. 1A to 16.

As described above, the third embodiment can obtain similar advantages to those of the first embodiment. In addition, it is possible to manipulate the operation unit of a dot figure by touch sense, to display characters, figures, maps, images and the like which can be visually recognized, and to manipulate while viewing the screen Although the embodiments of the present invention has been described, the present invention is not limited to the embodiments.

For example, in each embodiment, the main finger tip position on the pin matrix 3 is detected by using the marker attached to the main finger tip. Instead, the main finger tip may be recognized to identify the touch position, by an image recognition process of processing images of reflected infrared rays detected by the video camera. In this case, the main finger tip can be detected without using the marker made of recursive reflection material.

Further, each embodiment may be realized through identification of a main finger tip position and detection of a press force detected with one pressure sensor. For example, as shown in FIGS. 7A to 8B, if manipulation is conducted by the main finger tip 11 only, the position of the main finger tip is the barycenter position of a press force. In this case, it is not necessary to detect the barycenter of the press force by the pressure sensor, and it is sufficient to use as a pressure sensor only one pressure sensor for detecting a press force.

It should be further understood by those skilled in the art that although the foregoing description has been made on embodiments of the invention, the invention is not limited thereto and various changes and modifications may be made without departing from the spirit of the invention and the scope of the appended claims.

1. A dot figure display apparatus for displaying a dot figure on a pin matrix having a plurality of pins disposed in a matrix pattern on an upper surface of a dot figure display main body and allowing touch sense of said dot figure by touching said pin matrix with a finger tip, the dot figure display apparatus comprising:
an infrared LED for irradiating infrared rays to a surface of said pin matrix;
a video camera for receiving said infrared rays reflected and detecting an infrared ray image reflected from a main finger tip depressed said pin matrix;
a pressure sensor for detecting a press force to said pin matrix; and
a control unit for detecting a touch position of said main finger tip on said pin matrix as a main finger tip touch position, in accordance with a detection result of the reflected infrared ray image of said video camera and detecting a press force to said pin matrix from a detection output of said pressure sensor.

2. A dot figure display apparatus for displaying a dot figure on a pin matrix having a plurality of pins disposed in a matrix pattern on an upper surface of a dot figure display main body and allowing touch sense of said dot figure by touching said pin matrix with a finger tip, the dot figure display apparatus comprising:
an infrared LED for irradiating infrared rays to a surface of said pin matrix;
a video camera for receiving said infrared rays reflected to detect infrared rays reflected from a marker made of recursive reflection material and attached to a main finger tip depressed said pin matrix;
a pressure sensor for detecting a press force to said pin matrix; and
a control unit for detecting a touch position of said main finger tip on said pin matrix as a main finger tip touch position, in accordance with a detection result of the reflected infrared rays from said marker and detecting a press force to said pin matrix from a detection output of said pressure sensor.

3. A dot figure display apparatus for displaying a dot figure on a pin matrix having a plurality of pins disposed in a matrix pattern on an upper surface of a dot figure display main body and allowing touch sense of said dot figure by touching said pin matrix with a finger tip, the dot figure display apparatus comprising:
an infrared LED for irradiating infrared rays to a surface of said pin matrix;
a video camera for receiving said infrared rays reflected to detect infrared rays reflected from a marker made of recursive reflection material and attached to a main finger tip depressed said pin matrix;
a plurality of pressure sensors for detecting a press force to said pin matrix; and
a control unit for detecting a touch position of said main finger tip on said pin matrix as a main finger tip touch position, in accordance with a detection result of the reflected infrared rays from said marker and detecting a pressure barycenter position on and a press force to said pin matrix from a detection output of said plurality of pressure sensors.

4. The dot figure display apparatus according to claim 3, wherein:
said video camera includes a first video camera and a second video camera, and said infrared LED is disposed in front of said first and second video cameras; and
said control unit detects a direction from said first video camera toward said marker in accordance with the detection result of the reflected infrared rays from said marker by said first video camera, detects a direction from said second video camera toward said marker in accordance with the detection result of the reflected infrared rays from said marker by said second video camera, and detects the main finger tip touch position on said pin matrix in accordance with the direction from said first video camera toward said marker and the direction from said second video camera toward said marker.

5. The dot figure display apparatus according to claim 1, further comprising:
a projector screen covering a whole area of said pin matrix; and
a projector for projecting a character, a figure, a map, an image and the like on said projector screen.

6. The dot figure display apparatus according to claim 1, wherein if a detected value of said press force is a threshold value or larger, said control unit judges that said pin matrix was subjected to a touch manipulation, and in accordance with said touch manipulation, controls said dot figure displayed on said pin matrix.

7. The dot figure display apparatus according to claim 6, wherein if said press force by said main finger tip is said threshold value or larger and if said main finger tip touch position and said pressure barycenter position are in a range of said dot figure, said control unit controls to move or rotate said dot figure while said main finger tip touch position and said pressure barycenter position move.

8. The dot figure display apparatus according to claim 6, wherein if said press force is said threshold value or larger and if said main finger tip touch position and said pressure barycenter position are in a range of said dot figure, said control unit controls to change a size of said dot figure in accordance with a distance between said main finger tip touch position and said pressure barycenter position.

9. The dot figure display apparatus according to claim 6, wherein if said press force is said threshold value or larger and if said main finger tip touch position and said pressure barycenter position are in a range of said dot figure, said control unit controls to rotate said dot figure by using said main finger tip touch position as a rotation center, while said pressure barycenter position rotates by using said main finger tip touch position as a rotation center.

10. The dot figure display apparatus according to claim 6, wherein:
said dot figure displayed on said pin matrix includes a plurality of numerical value display areas for displaying a numerical value;
and if said press force is said threshold value or larger and if said main finger tip touch position is in a range of said dot figure of a predetermined numerical value display area among said plurality of numerical value display areas, said control unit controls to change a numerical value displayed in said predetermined numerical value display area, in accordance with a relation between said pressure barycenter position corresponding to depression of said pin matrix with a finger tip other than said main finger tip and a position of said predetermined numerical value display area.

11. The dot figure display apparatus according to claim 6, wherein:
said dot figure displayed on said pin matrix represents a floor operation unit of an elevator having a plurality of floor select buttons; and
if said press force is said threshold value or larger and if said main finger tip touch position is in a range of said dot figure of a predetermined floor select button, said control unit judges that a floor was designated by said predetermined floor select button, and outputs a command for moving the elevator to said designated floor to an elevator device.

12. The dot figure display apparatus according to claim 11, wherein:
said floor operation unit is provided in an elevator position display unit having a floor bar showing each floor by said dot figure; and a position bar showing a position of the elevator; and
said control unit controls to move said position bar in said elevator position display unit while the elevator moves.

13. The dot figure display apparatus according to claim 6, wherein:
said dot figure displayed on said bin matrix includes a text constituted of a character string and a scroll button for scrolling said text; and
if said pressure barycenter position is in a range of said dot figure of said scroll button, said control unit controls to scroll said text.

14. The dot figure display apparatus according to claim 6, wherein:
said dot figure displayed on said bin matrix displays an operation unit having a volume adjusting unit and an operation button of a sound reproducing apparatus; and
if said press force by said main finger tip is said threshold value or larger and if said main finger tip touch position is at a position of a volume adjusting bar of said volume adjusting unit, said control unit controls to change a reproduction volume of said sound reproducing apparatus while said main finger tip touch position moves.
